(19) United States
(12) Patent Application Publication
(10) Pub. No.: US 2014/0156358 A1
(43) Pub. Date: Jun. 5, 2014

(54) SYSTEM AND METHOD FOR UNIVERSITY MODEL GRAPH BASED VISUALIZATION

(71) Applicants: Sridhar Varadarajan, Bangalore (IN); Srividya Gopalan, Bangalore (IN); Preethy Iyer, Bangalore (IN)

(72) Inventors: Sridhar Varadarajan, Bangalore (IN); Srividya Gopalan, Bangalore (IN); Preethy Iyer, Bangalore (IN)

(73) Assignee: SRM INSTITUTE OF SCIENCE AND TECHNOLOGY, West Mambalam (IN)

(21) Appl. No.: 14/082,058

(22) Filed: Nov. 15, 2013

Related U.S. Application Data
(63) Continuation-in-part of application No. 12/909,988, filed on Oct. 22, 2010, now abandoned.

(30) Foreign Application Priority Data
Jun. 30, 2010 (IN) 1848/CHE/2010

(51) Int. Cl. G06Q 50/20; G06Q 10/06

(52) U.S. Cl. CPC G06Q 50/20; G06Q 10/06398
USPC 705/7.42

(57) ABSTRACT

An educational institution (also referred as a university) is rich with multiple kinds of data: students, faculty members, departments, divisions, and at university level. A structural representation that captures the essence of all of the relationships in a unified manner has concise information about the educational institution, and visualization is a way to bring out all this information in an explicit manner so that the various of the users of the educational institution system understand effectively their system. A system and method for visualization based on the structural representation of a university along a variety of dimensions is discussed.

1. A reference is made to the applicants' earlier Indian patent application titled “System and Method for an Influence based Structural Analysis of a University” with the application number 1269/CHE2010 filed on 6 May 2010.

2. A reference is made to another of the applicants' earlier Indian patent application titled “System and Method for Constructing a University Model Graph” that is under filing process and the application number and the filing date are yet to obtained.

### FIELD OF THE INVENTION

The present invention relates to the visualization of the information about a university in general, and more particularly, visualization of the university based on the structural representations. Still more particularly, the present invention relates to a system and method for multiple multi-dimensions based visualization of a model graph associated with the university.

### BACKGROUND OF THE INVENTION

An Educational Institution (EI) (also referred as university) comprises of a variety of entities: students, faculty members, departments, divisions, labs, libraries, special interest groups, etc. University portals provide information about the universities and act as a window to the external world. A typical portal of a university provides information related to (a) Goals, Objectives, Historical Information, and Significant Milestones, of the university; (b) Profile of the Labs, Departments, and Divisions; (c) Profile of the Faculty Members; (d) Significant Achievements; (e) Admission Procedures; (f) Information for Students; (g) Library; (h) On- and Off-Campus Facilities; (i) Research; (j) External Collaborations; (k) Information for Collaborators; (I) News and Events; (m) Alumni; and (n) Information Resources. It is a requirement to provide a visualization of the university information so that the various of the users of the educational institution system get the information of their need, interest, and choice in a very concise and comprehensive manner. In order to be able to assess the university in a manner for to be used for multiple purposes such as for prospective students, candidates exploring opportunities within the university, for the funding agencies, and for providing an objectivized view of the information for the university visitors, there is a need to provide the visualization of the information contained in a structural representation of the university that is based on the known information about the university. For example, the visualization provides prospective students to have a better understanding of the university they are exploring to enroll and funding agencies to get a better picture of the university that they are planning to fund.

### DESCRIPTION OF RELATED ART

U.S. Pat. No. 7,734,607 to Grinstein; Georges (Ashby, Mass.), Gee; Alexander (Lowell, Mass.), Cvek; Urska (Shreveport, La.), Goodell; Howard (Salem, N.H.), Li; Hongli (Westborough, Mass.), Yu; Min (North Chelmsford, Mass.), Zhou; Jianping (Acton, Mass.), Gupta; Vivek (Littleton, Mass.), Smrtic; Mary Beth (Westford, Mass.), Lawrence; Christine (Waltham, Mass.), Chiang; Chih-Hung (North Chelmsford, Mass.) for “Universal visualization platform” (issued on Jun. 8, 2010 and assigned to University of Massachusetts (Boston, Mass.)) provides methods and apparatus, including computer program products, for a universal visualization platform.

U.S. Pat. No. 7,730,085 to Hassan; Hany M.; (Cairo, EG); Mostafa; Hala; (Cairo, EG) for “Method and System for Extracting and Visualizing Graph-Structured Relations from Unstructured Text” (issued on Jun. 1, 2010 and assigned to International Business Machines Corporation (Armonk, N.Y.)) describes a system, method and computer program for automatically extracting and mining relations and related entities from unstructured text and representing the extracted information into a graph, and manipulating the resulting graph to gain more insight into the information it contains.

U.S. Pat. No. 6,515,666 to Cohen; Jonathan Drew (Hanover, Md.) for “Method for constructing graph abstractions” (issued on Feb. 4, 2003) describes a method of constructing graph abstractions using a computer and the abstraction is presented on a computer display for to be used by a human viewer to understand a more complicated set of raw graphs.

United States Patent Application 20070022000 titled “Data analysis using graphical visualization” by Bodart; Andrew J.; (New York, N.Y.); Vanier; William E.; (Bound Brook, N.J.) (filed on Jul. 22, 2005 and assigned to Accenture LLP, Palo Alto, Calif.) provides methods and systems are for creating interactive graphical representations (e.g., interactive radial graphs) of operational data in order to enhance root cause analysis and other forms of operational analysis.

“IVEA: An Information Visualization Tool for Personalized Exploratory Document Collection Analysis” by Thai; VinhTuan, Handschuh; Siegfried, and Decker; Stefan (appeared in the Proceedings of 5th European Semantic Web Conference (ESWC 2008), 1-5 Jun. 2008, Tenerife, Spain published by Springer as Lecture Notes in Computer Science volume 5021) describes IVEA (Information Visualization for Exploratory Document Collection Analysis), an innovative visualization tool which employs the PIMO (Personal Information Model) ontology to provide the knowledge workers with an interactive interface allowing them to browse for information in a personalized manner.

“Supporting the Analytical Reasoning Process in Information Visualization” by Shrinivasan; Yedendra and van Wijk; Jarke (appeared in the ACM Human Factors in Computing Systems (CHI), Florence, Italy, 5-10 Apr. 2008) describes a new information visualization framework that supports the analytical reasoning process.

“A Visual Mapping Approach for Trend Identification in Multi-Attribute Data” by Bockstedt; Jesse and Adomavicius; Gediminas (appeared in the Proceedings of the 17th Workshop on Information Technology and Systems (WITS'07), Montreal, Canada, December 2007) describes a temporal data analysis and visualization technique for representing trends in multi-attribute temporal data using a clustering-based approach.

“Visualizing Missing Data: Classification and Empirical Study” by Eaton; Cyntrica, Plaisant; Catherine, and Drizd; Terence (appeared in Proceedings of the Tenth IFIP TC13 International Conference on Human-Computer Interaction 12-16 Sep. 2005, Rome, Italy (INTERACT 2005), 861-872, Springer) describes the fact that the most visualization tools fail to provide support for missing data and provide a report on the sources of missing data and a categorization of visualization techniques based on the impact missing data have on the display.

The known systems do not address the issue of visualization based on a comprehensive modeling of an educational institution at various levels in order to be able to provide adequate views to help assess the educational institution at various levels. The present invention provides for system and method for visualization based on a comprehensive modeling of the educational institution at multiple levels based on a set of entities, a set of entity-instances, and the mutual influences among these entities and entity-instances.

### SUMMARY OF THE INVENTION

The primary objective of the invention is to provide multiple multi-dimensional views of the information of an educational institution in a concise and comprehensive manner for helping in the assessment of the educational institution at elemental and component levels.

One aspect of the present invention is to provide an abstract view, a details view, and a variations view of the educational institution along Influence dimension of an entity or an instance of an entity of the educational institution.

Another aspect of the present invention is to provide an abstract view, a details view, and a variations view of the educational institution along Assessment dimension of an entity or an instance of an entity of the educational institution.

Yet another aspect of the present invention is to provide an abstract view, a details view, and a variations view of the educational institution along Parametric dimension of an entity or an instance of an entity of the educational institution.

Another aspect of the present invention is to provide views of the educational institution along Relationship dimensions at pair of entities, multiple entities, and rel-based entities levels.

Yet another aspect of the present invention is to provide views of the educational institution along Partitioning dimensions based on syntactic partitioning, semantic partitioning, and denseness based partitioning.

Another aspect of the present invention is to provide views of the educational institution along Threshold dimensions based on goodness, averageness, and badness characterizations.

Yet another aspect of the present invention is to provide views of the educational institution along Tracker dimensions based on ascending, descending, and sustaining behaviors.

Another aspect of the present invention is to provide views of the educational institution along Performance dimensions bringing out Star, Gold, and Bronze performers.

Yet another aspect of the present invention is to provide views of the educational institution along Impact dimensions bringing out Sun-kind, moon-kind, and blackhole-kind impacts.

Another aspect of the present invention is to provide views of the educational institution along Chain dimensions brining out strong, weak, and strong-weak chains.

In a preferred embodiment, the present invention provides a system for a university model graph based visualization of the information about a university with the help of a plurality of assessments and a plurality of influence values contained in a university model graph database to help in providing an effective understanding of said university at multiple levels, said university having a plurality of entities and a plurality of entity-instances, wherein each of said plurality of entity-instances is an instance of an entity of said plurality of entities, and said university model graph having a plurality of models a plurality of abstract nodes, a plurality of nodes, a plurality of abstract edges, a plurality of semi-abstract edges, and a plurality of edges, with each abstract node of said plurality of abstract nodes corresponding to an entity of said plurality of entities,

each node of said plurality of nodes corresponding to an entity-instance of said plurality of entity-instances, and

each abstract node of said plurality of abstract nodes is associated with a model of said plurality of models, and

a node of said plurality of nodes is connected to an abstract node of said plurality of abstract nodes through an abstract edge of said plurality of abstract edges, wherein said node represents an instance of an entity associated with said abstract node and said node is associated with an instantiated model and a base score, wherein said instantiated model is based on a model associated with said abstract node, and said base score is computed based on said instantiated model and is a value between 0 and 1,

a source abstract node of said plurality of abstract nodes is connected to a destination abstract node of said plurality of abstract nodes by a directed abstract edge of said plurality of abstract edges and said directed abstract edge is associated with an entity influence value of said plurality of influence values, wherein said entity influence value is a value between −1 and +1;

a source node of said plurality of nodes is connected to a destination node of said plurality of nodes by a directed edge of said plurality of edges and said directed edge is associated with an influence value of said plurality influence values, wherein said influence value is a value between −1 and +1;

a source node of said plurality of nodes is connected to a destination abstract node of said plurality of abstract nodes by a directed semi-abstract edge of said plurality of semi-abstract edges and said directed semi-abstract edge is associated with an entity-instance-entity-influence value of said plurality influence values, wherein said influence value is a value between −1 and +1; and

a source abstract node of said plurality of abstract nodes is connected to a destination node of said plurality of nodes by a directed semi-abstract edge of said plurality of semi-abstract edges and said directed semi-abstract edge is associated with an entity-entity-instance-influence value of said plurality influence values, wherein said influence value is a value between −1 and +1, said system comprising,
means for providing of visualization of said university model graph of said university based on a three major dimensions consisting of an assessment dimension, an influence dimension, and a parametric dimension;
means for providing of visualization of said university model graph of said university based on a three minor dimensions consisting of an abstract view dimension, a details view dimension, and a variations view dimension;
means for providing of visualization of said university model graph of said university based on a three relationship dimensions consisting of a pair level dimension, a multiple level dimension, and a rel-based dimension;
means for providing of visualization of said university model graph of said university based on a three partition dimensions consisting of a syntactic partition dimension, a semantic partition dimension, and a denseness based partitioning;
means for providing of visualization of said university model graph of said university based on a three threshold dimensions consisting of a goodness dimension, an averageness dimension, and a badness dimension;
means for providing of visualization of said university model graph of said university based on a three tracker dimensions consisting of an ascending behavior dimension, a descending behavior dimension, and a sustaining behavior dimension;
means for providing of visualization of said university model graph of said university based on a three performance dimensions consisting of a star performer dimension, a gold performer dimension, and a bronze performer dimension;
means for providing of visualization of said university model graph of said university based on a three impact dimensions consisting of a sun-kind impact dimension, a moon-kind impact dimension, and a blackhole-kind impact dimension; and
means for providing of visualization of said university model graph of said university based on a three chain dimensions consisting of a strong chain dimension, a weak chain dimension, and a strong-weak chain dimension.

(BASED ON FIGS. 1, 1a, 1b, 2, and 3)

### BRIEF DESCRIPTION OF THE DRAWINGS

FIG. 1 provides an overview of an EI Visualization System.

FIG. 1a provides an illustrative University Model Graph.

FIG. 1b provides the elements of University Model Graph.

FIG. 2 depicts an illustrative EI Visualization Aspects.

FIG. 3 depicts an illustrative EI Visualization Dimensions.

FIG. 4 provides the visualization based on 3 Major Dimensions.

FIG. 5 describes an approach for 1-D Assessment Visualization.

FIG. 6 describes an approach for 1-D Influence Visualization.

FIG. 7 describes an approach for 1-D Parametric Visualization.

FIG. 8 describes an approach for 2-D Visualization based on Assessment and Influence Values.

FIG. 9 describes an approach for 2-D Visualization based on Assessment and Critical Parameter Values.

FIG. 10 describes an approach for Visualization based on Pair Relationship Dimension.

FIG. 10a provides an illustrative Visualization based on Pair Relationship Dimension.

FIG. 10b describes an approach for Visualization based on Multiple Relationship Dimension.

FIG. 10c describes an approach for Visualization based on Rel-based Relationship Dimension.

FIG. 11 describes an approach for Visualization based on Syntactic Partitioning.

FIG. 11a describes an approach for Visualization based on Semantic Partitioning.

FIG. 11b describes an approach for Visualization based on Denseness Partitioning.

FIG. 12 describes an approach for Visualization based on Threshold Dimensions.

FIG. 13 describes an approach for Visualization based on Tracker Dimensions.

FIG. 14 describes an approach for Visualization based on Performance Dimensions.

FIG. 15 describes an approach for Visualization based on Impact Dimensions.

FIG. 16 describes an approach for Visualization based on Chain Dimensions.

FIG. 17 depicts an illustrative University Visualization System.

FIG. 18 depicts an approach for Leadership Assessment.

FIG. 18A provides an approach for computing Follow Quotient.

FIG. 18B provides an approach for computing Sustain Quotient.

FIG. 19 depicts an approach for Mentorship Assessment.

FIG. 19A provides an approach for Mentee identification.

FIG. 20 depicts an approach for Dependability Assessment.

FIG. 20A provides an approach for determining typical Meeting Times.

FIG. 21 provides an illustrative computation of Leadership Assessment.

FIG. 21A provides an illustrative computation of Mentorship Assessment.

FIG. 21B provides an illustrative computation of Dependability Assessment.

FIG. 21C provides additional information related to the illustrative computation of Dependability Assessment.

FIG. 21D provides some more information related to the Illustrative computation of Dependability Assessment.

### DETAILED DESCRIPTION OF THE PREFERRED EMBODIMENTS

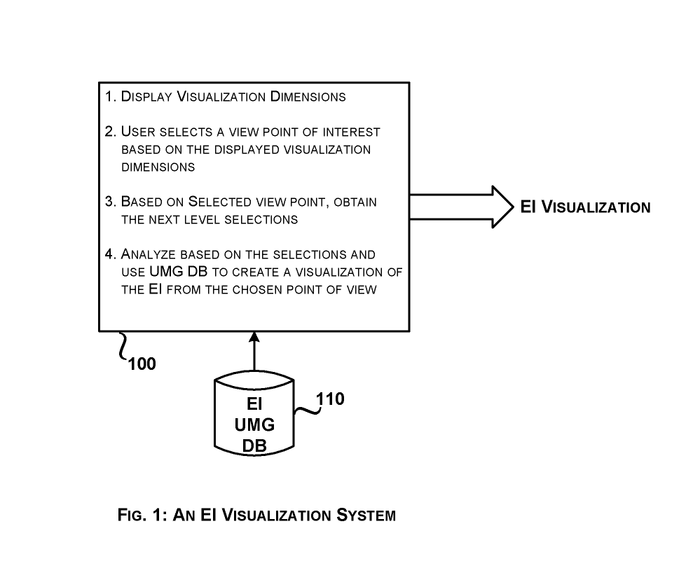

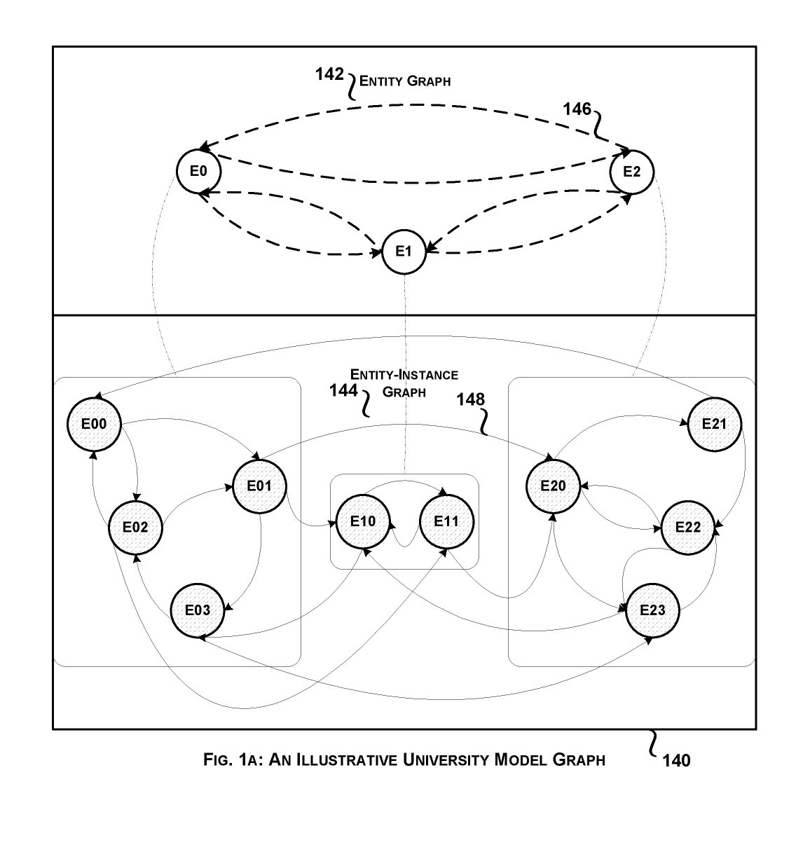

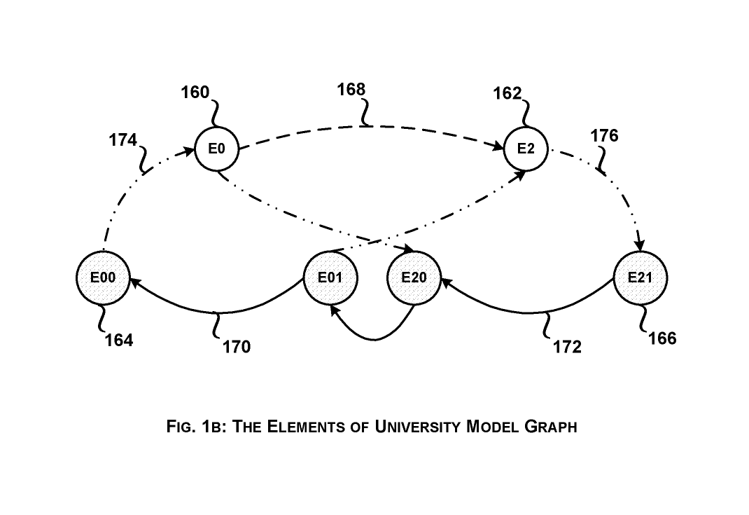

FIG. 1 depicts an overview of EI Visualization System. The main steps (100) are to select a view point of interest to a user so that University Model Graph (UMG) Database (DB) (110) of a university is analyzed from the selected view point to create the view point visualization. Note that, in the sequel, “university” and “educational institution” are used interchangeably. UMG database comprises of a university model graph associated with the university that is a structural representation of the information about the educational institution.

FIG. 1a depicts an illustrative University Model Graph. 140 describes UMG as consisting of two main components: Entity Graph (142) and Entity-Instance Graph (144). Entity graph consists of entities of the university as its nodes and an abstract edge (146) or abstract link is a directed edge that connects two entities of the entity graph. Note that edge and link are used interchangeably. The weight associated with this abstract edge is the influence factor or influence value indicating nature and quantum of influence of the source entity on the destination entity. Again, influence factor and influence value are used interchangeably. Similarly, the nodes in the entity-instance graph are the entity instances and the edge (148) or the link between two entity-instances is a directed edge and the weight associated with the edge indicates the nature and quantum of influence of the source entity-instance on the destination entity-instance.

FIG. 1b provides the elements of a University Model Graph. The fundamental elements are nodes and edges. There are two kinds of nodes: Abstract nodes (160 and 162) and Nodes (164 and 166); There are three kinds of directed edges or links: Abstract links (168), links (170 and 172), and semi-abstract links (174 and 176). As part of the modeling, the abstract nodes are mapped onto entities and nodes are mapped onto the instances of the entities; the weight associated with an abstract link corresponds to an entity influence value (EI-Value), the weight associated with a semi-abstract link corresponds to either an entity-entity-instance influence value (EIEI-Value) or an entity-instance-entity influence value (IEEI-Value), and finally, the weight associated with a link corresponds to an entity-instance influence value (I-Value). Note that edges and links are used interchangeably. Further, each entity is associated with a model and an instance of an entity is associated with a base score and an instantiated model, wherein the base score is computed based on the associated instantiated model and denotes the assessment of the entity instance.

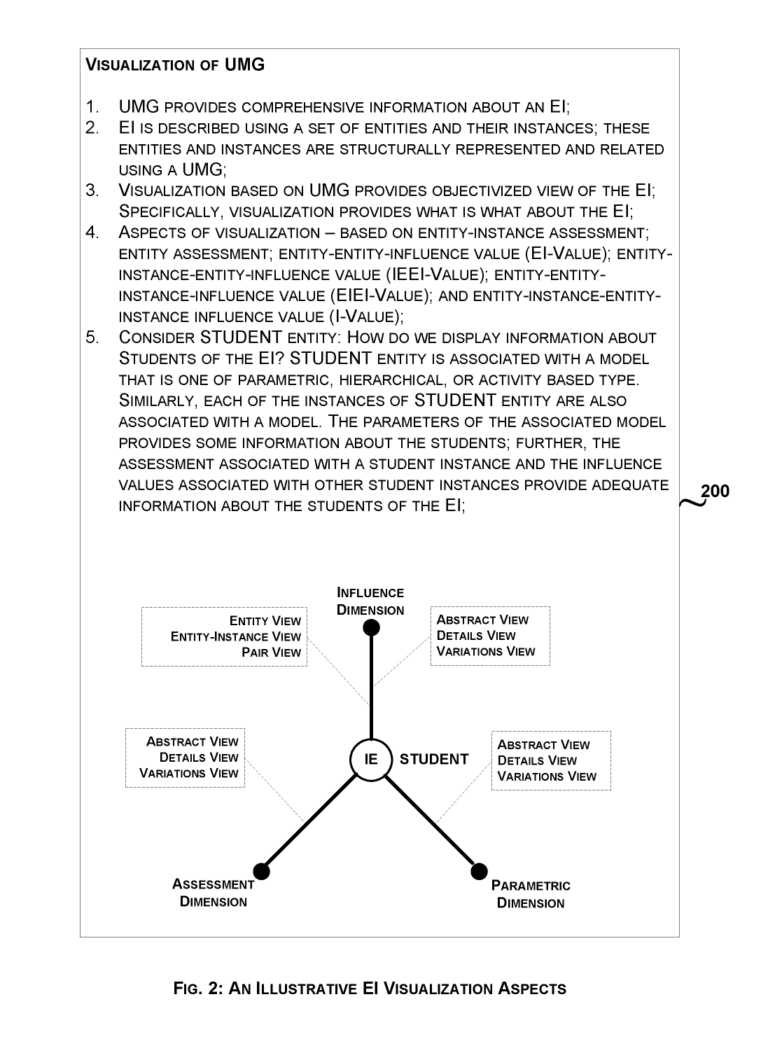

FIG. 2 provides an Illustrative EI Visualization Aspects.

Visualization of UMG (200):
1. UMG provides comprehensive information about an EI;
2. EI is described using a set of entities and their instances; these entities and instances are structurally represented and related using a UMG;
3. Visualization based on UMG provides objectivized view of the EI; Specifically, visualization provides what is what about the EI;
4. Aspects of visualization—based on entity-instance assessment; entity assessment; entity-entity-influence value (EI-Value); entity-instance-entity-influence value (IEEI-Value); entity-entity-instance-influence value (EIEI-Value); and entity-instance-entity-instance influence value (I-Value);
5. Consider STUDENT entity: How do we display information about Students of the EI? STUDENT entity is associated with a model that is one of parametric, hierarchical, or activity based type. Similarly, each of the instances of STUDENT entity are also associated with a model. The parameters of the associated model provides some information about the students; further, the assessment associated with a student instance and the influence values associated with other student instances provide adequate information about the students of the EI;

Note that there are three dimensions of interest: Influence dimension, Assessment dimension, and Parametric dimension. For each of these three dimensions, the information gets visualized at abstract level (conciseness), details level (comprehensiveness), and variations (time based) level. Further, the above multi-dimensional view is provide for an entity, an entity-instance, a pair of entities, or a pair of entity instances.

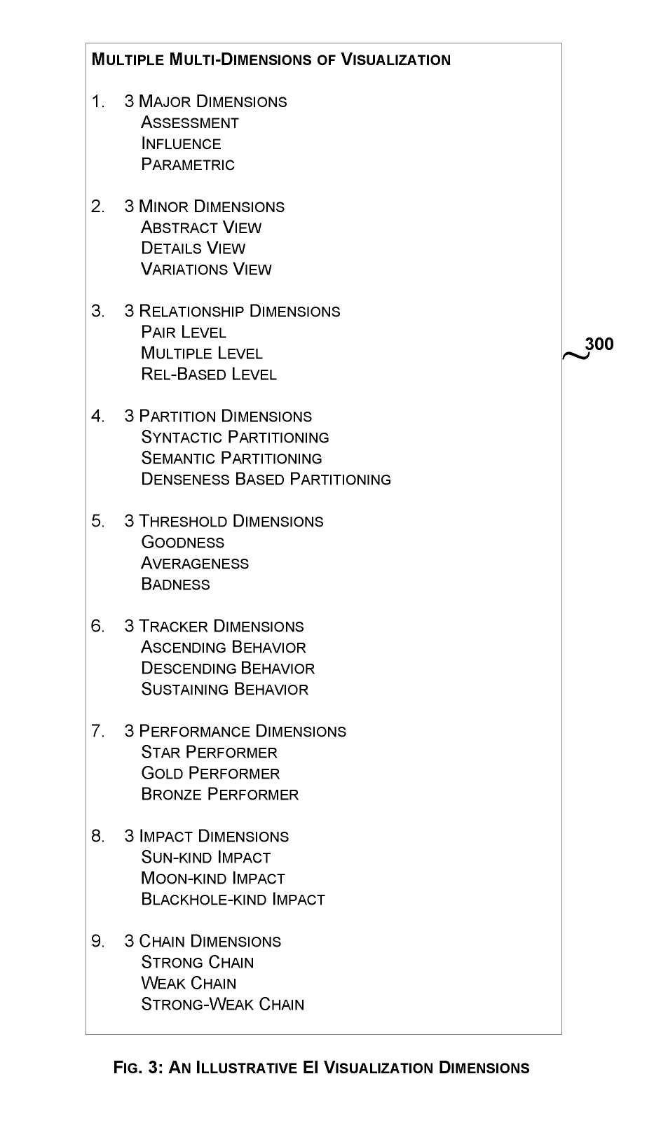

FIG. 3 depicts an Illustrative EI Visualization Dimensions.

Multiple Multi-Dimensions of Visualization (300): The visualization exploits all of the information available in UMG and brings it out in multiple ways for information dissemination. These multiple ways are being called as multiple dimensions and the corresponding means are as follows:
1. Means for providing of visualization of a university model graph of a university based on 3 Major Dimensions are:
   Assessment dimension
   Influence dimension
   Parametric dimension

Each entity or entity-instance has an assessment associated with it and is based on a model that is parametric. Similarly each entity or entity-instance influences another entity or entity-instance; Visualization brings out all of these in an effective manner for the users of the EI Visualization System to get a better understanding of the education institution.
2. Means for providing of visualization of the university model graph of the university based on 3 Minor Dimensions are:
   Abstract View dimension
   Details View dimension
   Variations View dimension

Each of the three major dimensions is elaborated using the above mentioned three minor dimensions. That is, for example, an entity-instance assessment gets described in an abstract view that provides an assessment summary information while in a details view, the assessment information gets provides over a period of time.
3. Means for providing of visualization of the university model graph of the university based on 3 Relationship Dimensions are:
   Pair Level dimension
   Multiple Level dimension
   Rel-Based dimension

A kind of visualization involves analyzing and displaying information about a set of entities or entity-instances. And, this set consists of a pair of entities or entity-instances, an explicitly defined set of entities or entity-instances, or implicitly defined using a relationship.
4. Means for providing of visualization of the university model graph of the university based on 3 Partition Dimensions are:
   Syntactic Partitioning dimension
   Semantic Partitioning dimension
   Denseness Based Partitioning dimension

Another useful visualization involves partitioning of a UMG based on, say, syntactic conditions, semantic conditions, or certain special conditions, and depicting the characteristic of the educational institution based on characterization of the elements of the partition.
5. Means for providing of visualization of the university model graph of the university based on 3 Threshold Dimensions are:
   Goodness dimension
   Averageness dimension
   Badness dimension

This utilizes pre-defined thresholds to provide a useful visualization of the UMG.
6. Means for providing of visualization of the university model graph of the university based on 3 Tracker Dimensions are:
   Ascending Behavior dimension
   Descending Behavior dimension
   Sustaining Behavior dimension

These dimensions are combined with threshold dimensions to depict UMG based information over a period of time.
7. Means for providing of visualization of the university model graph of the university based on 3 Performance Dimensions are:
   Star Performer dimension
   Gold Performer dimension
   Bronze Performer dimension

These dimensions provide a performance based visualization of UMG.
8. Means for providing of visualization of the university model graph of the university based on 3 Impact Dimensions are:
   Sun-kind Impact dimension
   Moon-kind Impact dimension
   Blackhole-kind Impact dimension

These dimensions help visualize the impact of the entities and entity-instances.
9. Means for providing of visualization of the university model graph of the university based on 3 Chain Dimensions are:
   Strong Chain dimension
   Weak Chain dimension
   Strong-Weak Chain dimension

This visualization is based on the identification of a set of chains based on UMG and characterization of the same to provide yet another view point of the educational institution.

It is stated here that the visualization along the above multiple multi-dimensions is applicable with respect to the following: Entities that a part of UMG, Entity-Instances that a part of UMG, and any combination of Entities and Entity-Instances.

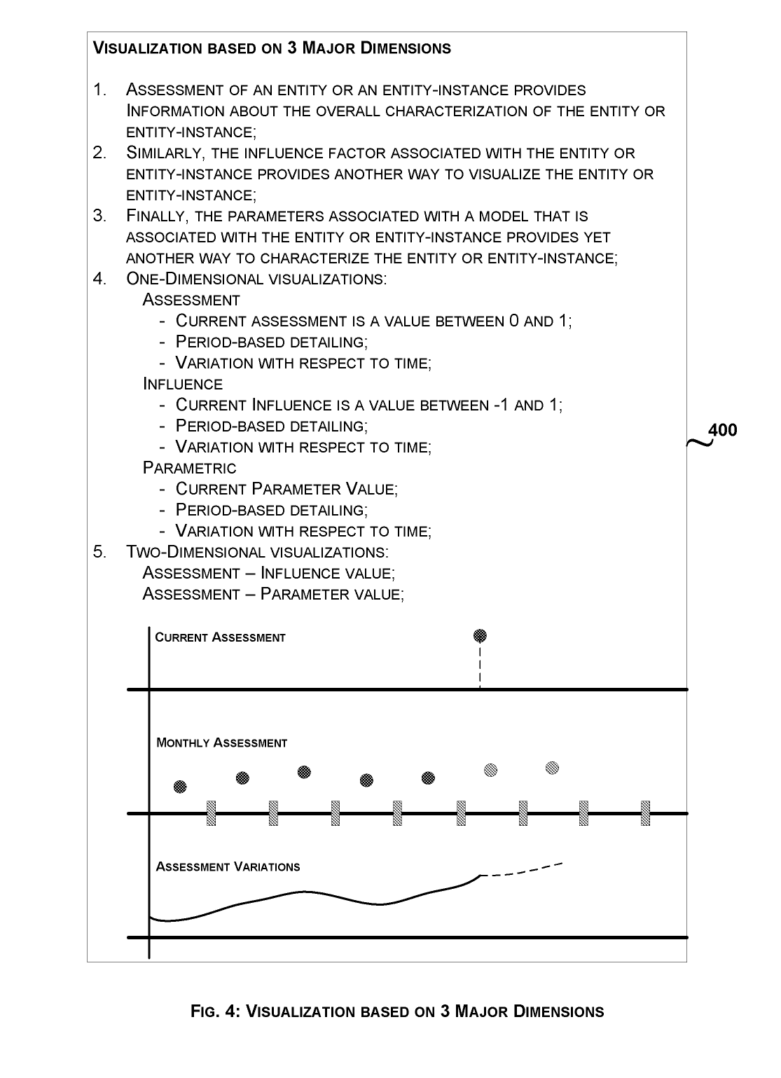

FIG. 4 depicts the Visualization based on 3 Major Dimensions.

Means and Characteristics of Visualization Based on 3 Major Dimensions (400):
1. Assessment of an entity or an entity-instance provides Information about the overall characterization of the entity or entity-instance;
2. Similarly, the influence factor associated with the entity or entity-instance provides another way to visualize the entity or entity-instance;
3. Finally, the parameters associated with a model that is associated with the entity or entity-instance provides yet another way to characterize the entity or entity-instance;
4. One-Dimensional visualizations:
   Assessment
      Current assessment is a value between 0 and 1;
      Period-based detailing;
      Variation with respect to time;
   Influence
      Current Influence is a value between −1 and 1;
      Period-based detailing;
      Variation with respect to time;
   Parametric
      Current Parameter Value;
      Period-based detailing;
      Variation with respect to time;
5. Two-Dimensional visualizations:
   Assessment—Influence value;
      Assessment—Parameter value;

As depicted, Current Assessment is a single value between 0 and 1, while Monthly Assessment provides detailing of the assessment over a period with the computed abstracted monthly values. Finally, the variations provide how assessment varies over a period of time. Note that both monthly assessments and assessment variations provide an opportunity to look into future through predictions.

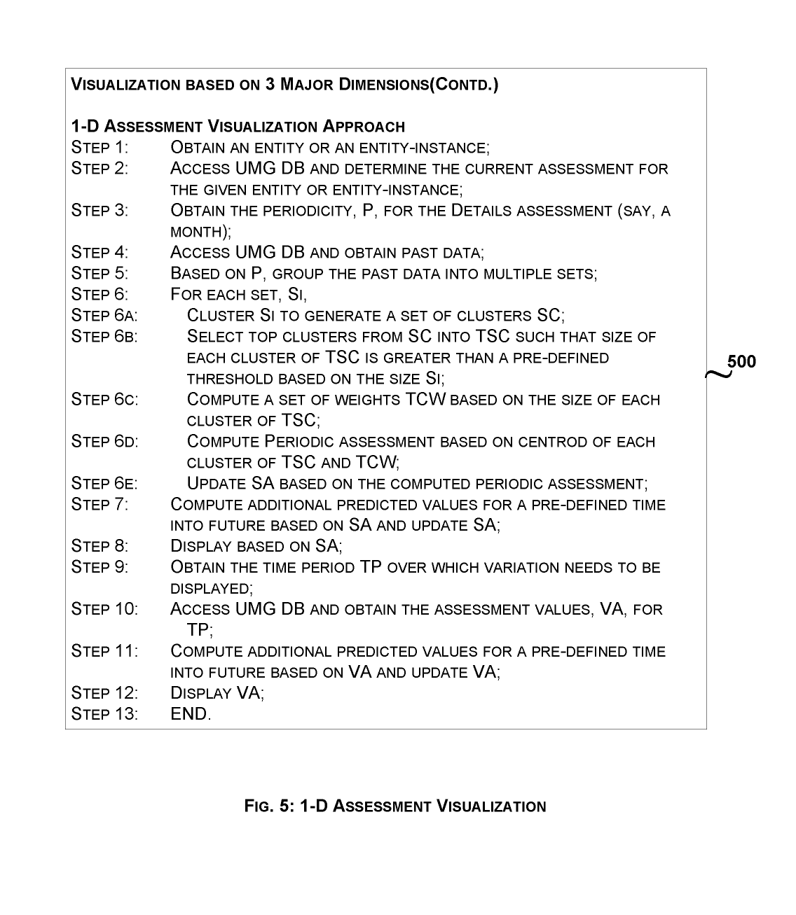

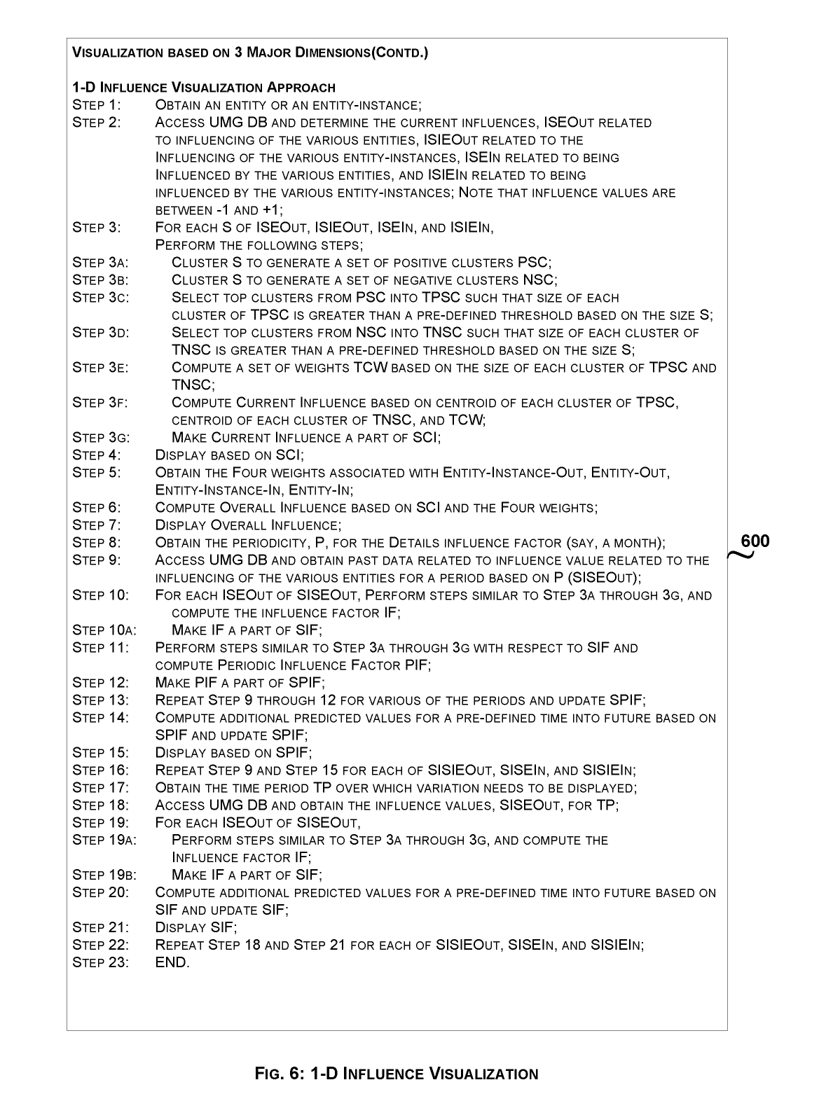

FIG. 5 describes an approach for 1-D Assessment Visualization.

Visualization Based on 3 Major Dimensions (Contd.)

Means and Approach for 1-D Assessment Visualization (500):
Step 1: Obtain an entity or an entity-instance;
Step 2: Access UMG DB and determine the current assessment for the given entity or entity-instance;
Step 3: Obtain the periodicity, P, for the Details assessment (say, a month);
Step 4: Access UMG DB and obtain past data;
Step 5: Based on P, group the past data into multiple sets;
Step 6: For each set, Si,
Step 6a: Cluster Si to generate a set of clusters SC;
Step 6b: Select top clusters from SC into TSC such that size of each cluster of TSC is greater than a pre-defined threshold based on the size Si;
Step 6c: Compute a set of weights TCW based on the size of each cluster of TSC;
Step 6d: Compute Periodic assessment based on centroid of each cluster of TSC and TCW; Step 6e: Update SA based on the computed periodic assessment;
Step 7: Compute additional predicted values for a pre-defined time into future based on SA and update SA;
Step 8: Display based on SA;
Step 9: Obtain the time period TP over which variation needs to be displayed;
Step 10: Access UMG DB and obtain the assessment values, VA, for TP;
Step 11: Compute additional predicted values for a pre-defined time into future based on VA and update VA;
Step 12: Display VA;
Step 13: END.

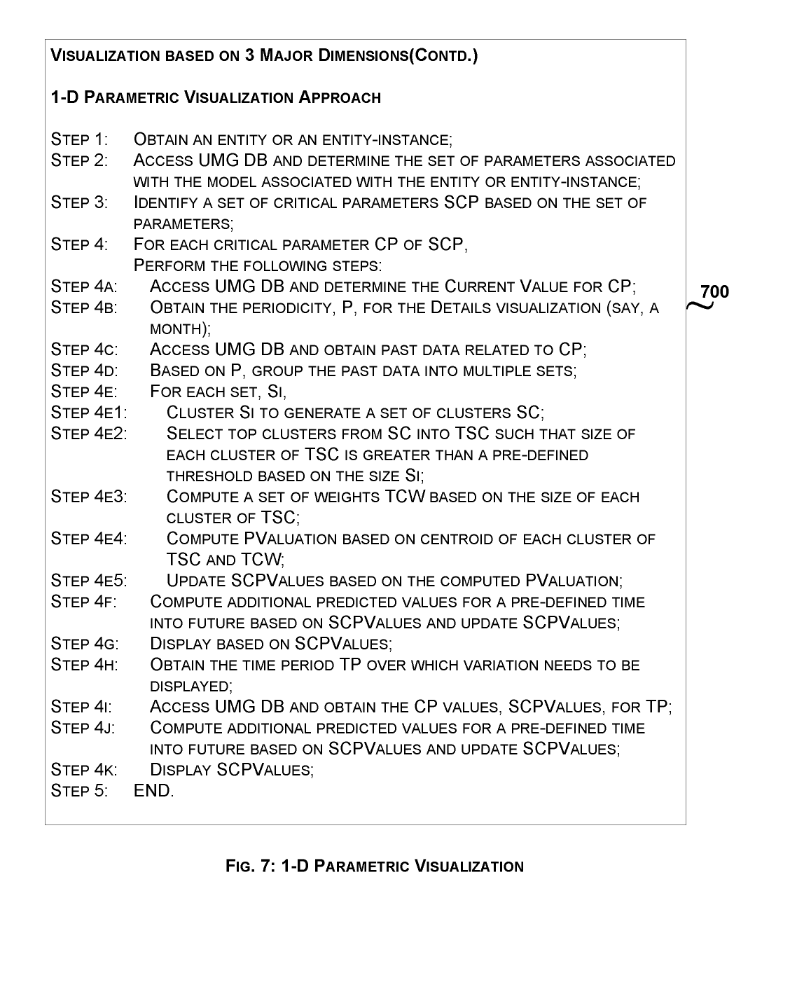

FIG. 6 describes an approach for 1-D Influence Visualization.

Visualization Based on 3 Major Dimensions (Contd.)

Means and Approach for 1-D Influence Visualization (600):
Step 1: Obtain an entity or an entity-instance;
Step 2: Access UMG DB and determine the current influences, ISEOut related to influencing of the various entities, ISIEOut related to the influencing of the various entity-instances, ISEIn related to being influenced by the various entities, and ISIEIn related to being influenced by the various entity-instances; Note that influence values are between −1 and +1;
Step 3: For each S of ISEOut, ISIEOut, ISEIn, and ISIEIn, Perform the following steps;
Step 3a: Cluster S to generate a set of positive clusters PSC;
Step 3b: Cluster S to generate a set of negative clusters NSC;
Step 3c: Select top clusters from PSC into TPSC such that size of each cluster of TPSC is greater than a pre-defined threshold based on the size S;
Step 3d: Select top clusters from NSC into TNSC such that size of each cluster of TNSC is greater than a pre-defined threshold based on the size S;
Step 3e: Compute a set of weights TCW based on the size of each cluster of TPSC and TNSC;
Step 3f: Compute Current Influence based on centroid of each cluster of TPSC, centroid of each cluster of TNSC, and TCW;
Step 3g: Make Current Influence a part of SCI;
Step 4: Display based on SCI;
Step 5: Obtain the Four weights associated with Entity-Instance-Out, Entity-Out, Entity-Instance-In, Entity-In;
Step 6: Compute Overall Influence based on SCI and the Four weights;
Step 7: Display Overall Influence;
Step 8: Obtain the periodicity, P, for the Details influence factor (say, a month);
Step 9: Access UMG DB and obtain past data related to influence value related to the influencing of the various entities for a period based on P (SISEOut);
Step 10: For each ISEOut of SISEOut, Perform steps similar to Step 3a through 3g, and compute the influence factor IF;
Step 10a: Make IF a part of SIF;
Step 11: Perform steps similar to Step 3a through 3g with respect to SIF and compute Periodic Influence Factor PIF;
Step 12: Make PIF a part of SPIF;
Step 13: Repeat Step 9 through 12 for various of the periods and update SPIF;
Step 14: Compute additional predicted values for a pre-defined time into future based on SPIF and update SPIF;
Step 15: Display based on SPIF;
Step 16: Repeat Step 9 and Step 15 for each of SISIEOut, SISEIn, and SISIEIn;
Step 17: Obtain the time period TP over which variation needs to be displayed;
Step 18: Access UMG DB and obtain the influence values, SISEOut, for TP;
Step 19: For each ISEOut of SISEOut,
Step 19a: Perform steps similar to Step 3a through 3g, and compute the Influence factor IF;
Step 19b: Make IF a part of SIF;
Step 20: Compute additional predicted values for a pre-defined time into future based on SIF and update SIF;
Step 21: Display SIF;
Step 22: Repeat Step 18 and Step 21 for each of SISIEOut, SISEIn, and SISIEIn;
Step 23: END.

FIG. 7 describes an approach for 1-D Parametric Visualization.

Visualization Based on 3 Major Dimensions(Contd.)

Means and Approach for 1-D Parametric Visualization (700):
Step 1: Obtain an entity or an entity-instance;
Step 2: Access UMG DB and determine the set of parameters associated with the model associated with the entity or entity-instance;
Step 3: Identify a set of critical parameters SCP based on the set of parameters;
Step 4: For each critical parameter CP of SCP, Perform the following steps:
Step 4a: Access UMG DB and determine the Current Value for CP;
Step 4b: Obtain the periodicity, P, for the Details visualization (say, a month);
Step 4c: Access UMG DB and obtain past data related to CP;
Step 4d: Based on P, group the past data into multiple sets;
Step 4e: For each set, Si,
Step 4e1: Cluster Si to generate a set of clusters SC;
Step 4e2: Select top clusters from SC into TSC such that size of each cluster of TSC is greater than a pre-defined threshold based on the size Si;
Step 4e3: Compute a set of weights TCW based on the size of each cluster of TSC;
Step 4e4: Compute PValuation based on centroid of each cluster of TSC and TCW;
Step 4e5: Update SCPValues based on the computed PValuation;
Step 4f: Compute additional predicted values for a pre-defined time into future based on SCPValues and update SCPValues;
Step 4g: Display based on SCPValues;
Step 4h: Obtain the time period TP over which variation needs to be displayed;
Step 4i: Access UMG DB and obtain the CP values, SCPValues, for TP;
Step 4j: Compute additional predicted values for a pre-defined time into future based on SCPValues and update SCPValues;
Step 4k: Display SCPValues;
Step 5: END.

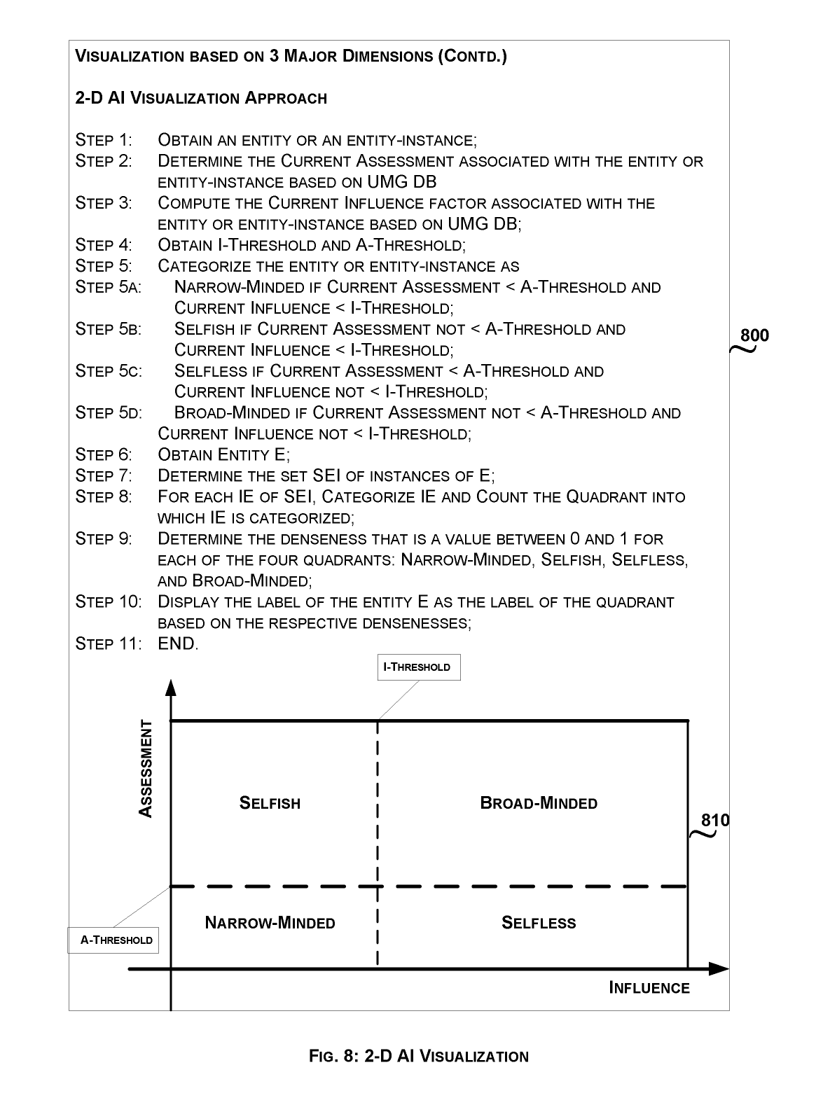

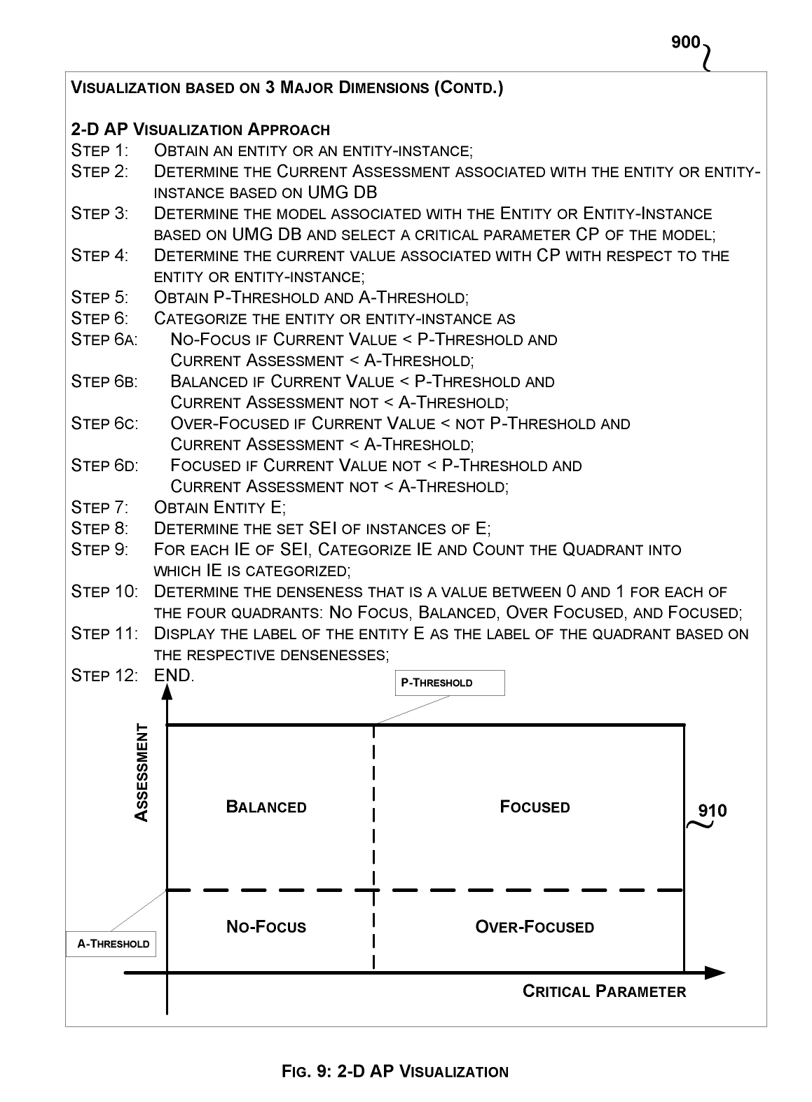

FIG. 8 describes an approach for 2-D Visualization based on Assessment (A) and Influence (I) Values.

Visualization Based on 3 Major Dimensions (Contd.)

Means and Approach for 2-D AI Visualization (800):
Step 1: Obtain an entity or an entity-instance;
Step 2: Determine the Current Assessment associated with the entity or entity-instance based on UMG DB
Step 3: Compute the Current Influence factor associated with the entity or entity-instance based on UMG DB;
Step 4: Obtain I-Threshold and A-Threshold;
Step 5: Categorize the entity or entity-instance as
Step 5a: Narrow-Minded if Current Assessment<A-Threshold and Current Influence<I-Threshold;
Step 5b: Selfish if Current Assessment not<A-Threshold and Current Influence<I-Threshold;
Step 5c: Selfless if Current Assessment<A-Threshold and Current Influence not<I-Threshold;
Step 5d: Broad-Minded if Current Assessment not<A-Threshold and Current Influence not<I-Threshold;
Step 6: Obtain Entity E;
Step 7: Determine the set SEI of instances of E;
Step 8: For each IE of SEI, Categorize IE and Count the Quadrant into which IE is categorized;
Step 9: Determine the denseness that is a value between 0 and 1 for each of the four quadrants: Narrow-Minded, Selfish, Selfless, and Broad-Minded;
Step 10: Display the label of the entity E as the label of the quadrant based on the respective densenesses;
Step 11: END.

810 provides a depiction of the four quadrants. The lower left quadrant is labeled “Narrow-Minded,” the upper left quadrant is labeled “Selfish,” the lower right quadrant is labeled “Selfless,” and the magic quadrant is the upper right quadrant that is labeled “Broad-Minded.” Note that these quadrants are defined based on two threshold values, namely, A-Threshold and I-Threshold.

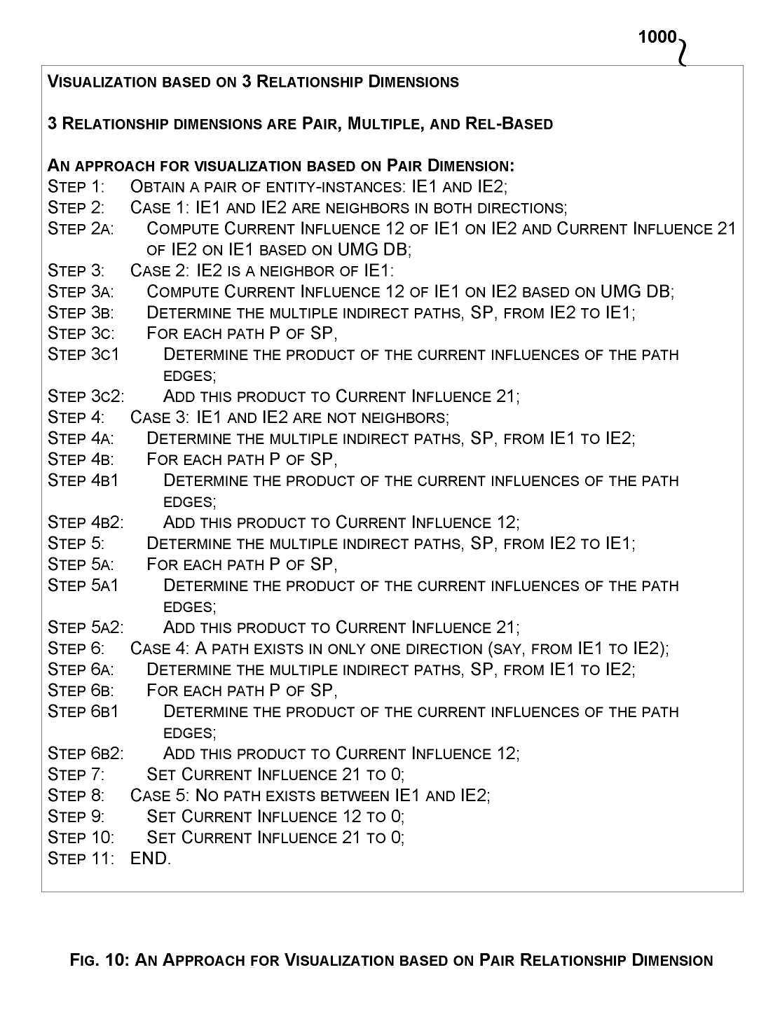

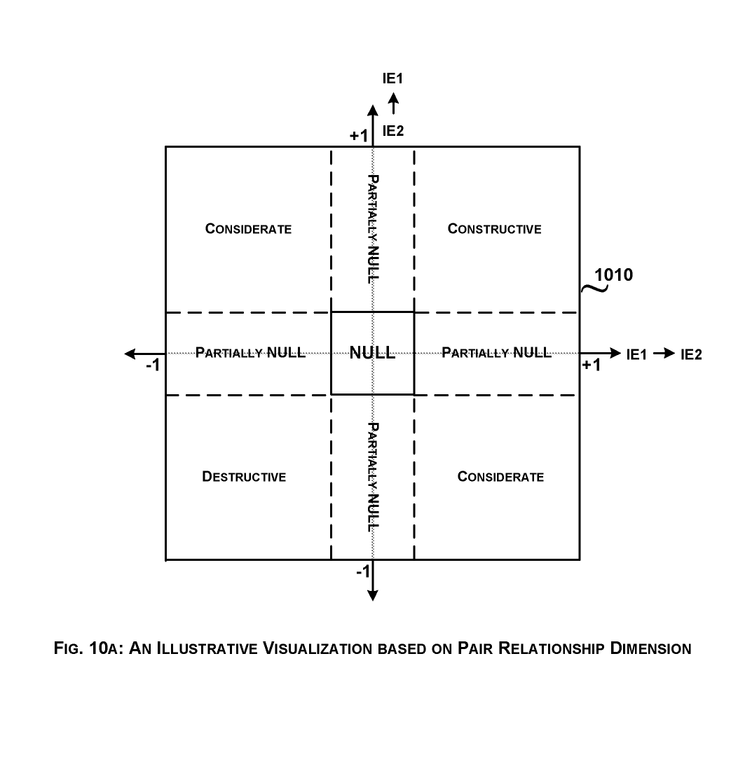

FIG. 9 describes an approach for 2-D Visualization based on Assessment (A) and Critical Parameter (P) Values.

Visualization Based on 3 Major Dimensions (Contd.)

Means and Approach for 2-D AP Visualization (900):
Step 1: Obtain an entity or an entity-instance;
Step 2: Determine the Current Assessment associated with the entity or entity-instance based on UMG DB
Step 3: Determine the model associated with the Entity or Entity-Instance based on UMG DB and select a critical parameter CP of the model;
Step 4: Determine the current value associated with CP with respect to the entity or entity-instance;
Step 5: Obtain P-Threshold and A-Threshold;
Step 6: Categorize the entity or entity-instance as
Step 6a: No-Focus if Current Value<P-Threshold and Current Assessment<A-Threshold;
Step 6b: Balanced if Current Value<P-Threshold and Current Assessment not<A-Threshold;
Step 6c: Over-Focused if Current Value<not P-Threshold and Current Assessment<A-Threshold;
Step 6d: Focused if Current Value not<P-Threshold and Current Assessment not<A-Threshold;
Step 7: Obtain Entity E;
Step 8: Determine the set SEI of instances of E;
Step 9: For each IE of SEI, Categorize IE and Count the Quadrant into which IE is categorized;
Step 10: Determine the denseness that is a value between 0 and 1 for each of the four quadrants: No Focus, Balanced, Over Focused, and Focused;
Step 11: Display the label of the entity E as the label of the quadrant based on the respective densenesses;
Step 12: END.

910 provides a depiction of the four quadrants. The lower left quadrant is labeled “No-Focus,” the upper left quadrant is labeled “Balanced,” the lower right quadrant is labeled “Over-Focused,” and the magic quadrant is the upper right quadrant that is labeled “Focused.” Note that these quadrants are defined based on two threshold values, namely, A-Threshold and P-Threshold.

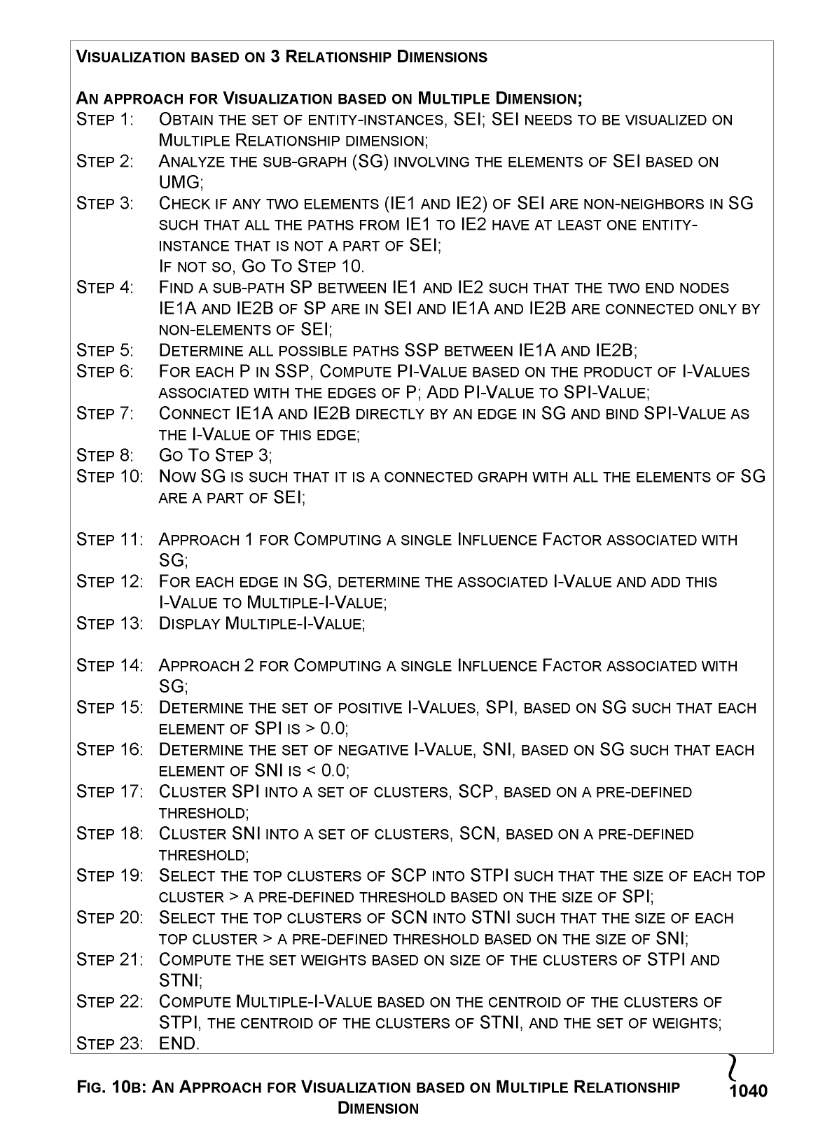

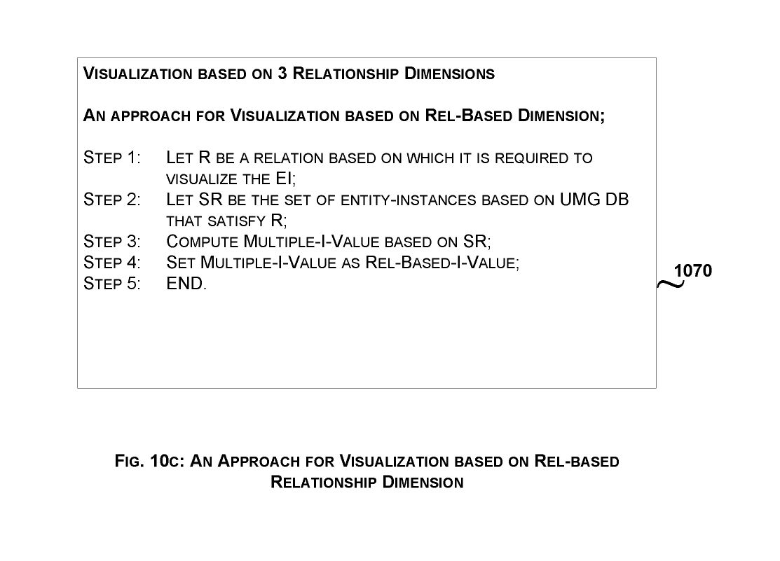

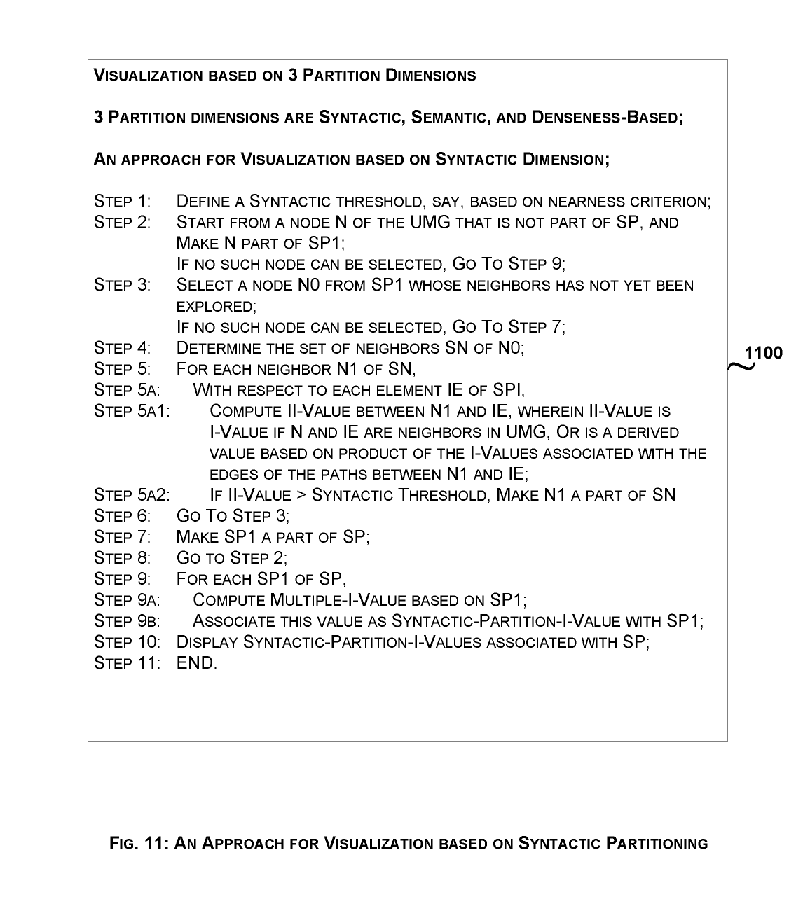

FIG. 10 describes an approach for Visualization based on Pair Relationship Dimension.

Visualization Based on 3 Relationship Dimensions

3 Relationship Dimensions are Pair, Multiple, and Rel-Based

Means and Approach for Visualization Based on Pair Dimension (1000):
Step 1: Obtain a pair of entity-instances: IE1 and IE2;
Step 2: Case 1: IE1 and IE2 are neighbors in both directions;
Step 2a: Compute Current Influence 12 of IE1 on IE2 and Current Influence 21 of IE2 on IE1 based on UMG DB;
Step 3: Case 2: IE2 is a neighbor of IE1:
Step 3a: Compute Current Influence 12 of IE1 on IE2 based on UMG DB;
Step 3b: Determine the multiple indirect paths, SP, from IE2 to IE1;
Step 3c: For each path P of SP,
Step 3c1 Determine the product of the current influences of the path edges;
Step 3c2: Add this product to Current Influence 21;
Step 4: Case 3: IE1 and IE2 are not neighbors;
Step 4a: Determine the multiple indirect paths, SP, from IE1 to IE2;
Step 4b: For each path P of SP,
Step 4b1 Determine the product of the current influences of the path edges;
Step 4b2: Add this product to Current Influence 12;
Step 5: Determine the multiple indirect paths, SP, from IE2 to IE1;
Step 5a: For each path P of SP,
Step 5a1 Determine the product of the current influences of the path edges;
Step 5a2: Add this product to Current Influence 21;
Step 6: Case 4: A path exists in only one direction (say, from IE1 to IE2);
Step 6a: Determine the multiple indirect paths, SP, from IE1 to IE2;
Step 6b: For each path P of SP,
Step 6b1 Determine the product of the current influences of the path edges;
Step 6b2: Add this product to Current Influence 12;
Step 7: Set Current Influence 21 to 0;
Step 8: Case 5: No path exists between IE1 and IE2;
Step 9: Set Current Influence 12 to 0;
Step 10: Set Current Influence 21 to 0;
Step 11: END.

FIG. 10a provides an illustrative Visualization based on Pair Relationship Dimension. In this illustration (1010), X-axis denotes the quantum of influence of IE1 on IE2 and Y-axis denotes the quantum of influence of IE2 on IE1. Close to origin, denotes a very low level influence of two entity-instances on each other and this close region is denoted as a NULL region. Similarly, the regions close to the two axes denote PARTIALLY NULL regions. The region wherein both entity-instances positively influence each other is denoted as CONSTRUCTIVE while the region wherein both entity-instances negatively influence each other is denoted as DESTRUCTIVE; The other two regions, wherein one of the entity-instances positively influences the other, and the other negatively is labeled CONSIDERATE.

FIG. 10b describes an approach for Visualization based on Multiple Relationship Dimension.

Visualization Based on 3 Relationship Dimensions

Means and Approach for Visualization Based on Multiple Dimension (1040):
Step 1: Obtain the set of entity-instances, SEI; SEI needs to be visualized on Multiple Relationship dimension;
Step 2: Analyze the sub-graph (SG) involving the elements of SEI based on UMG;
Step 3: Check if any two elements (IE1 and IE2) of SEI are non-neighbors in SG such that all the paths from IE1 to IE2 have at least one entity-instance that is not a part of SEI; If not so, Go To Step 10.
Step 4: Find a sub-path SP between IE1 and IE2 such that the two end nodes IE1A and IE2B of SP are in SEI and IE1A and IE2B are connected only by non-elements of SEI;
Step 5: Determine all possible paths SSP between IE1A and IE2B;
Step 6: For each P in SSP, Compute PI-Value based on the product of I-Values associated with the edges of P; Add PI-Value to SPI-Value;
Step 7: Connect IE1A and IE2B directly by an edge in SG and bind SPI-Value as the I-Value of this edge;
Step 8: Go To Step 3;
Step 10: Now SG is such that it is a connected graph with all the elements of SG are a part of SEI;
Step 11: Approach 1 for Computing a single Influence Factor associated with SG;
Step 12: For each edge in SG, determine the associated I-Value and add this I-Value to Multiple-I-Value;
Step 13: Display Multiple-I-Value;
Step 14: Approach 2 for Computing a single Influence Factor associated with SG;
Step 15: Determine the set of positive I-Values, SPI, based on SG such that each element of SPI is >0.0;
Step 16: Determine the set of negative I-Value, SNI, based on SG such that each element of SNI is <0.0;
Step 17: Cluster SPI into a set of clusters, SCP, based on a pre-defined threshold;
Step 18: Cluster SNI into a set of clusters, SCN, based on a pre-defined threshold;
Step 19: Select the top clusters of SCP into STPI such that the size of each top cluster>a pre-defined threshold based on the size of SPI;
Step 20: Select the top clusters of SCN into STNI such that the size of each top cluster>a pre-defined threshold based on the size of SNI;
Step 21: Compute the set weights based on size of the clusters of STPI and STNI;
Step 22: Compute Multiple-I-Value based on the centroid of the clusters of STPI, the centroid of the clusters of STNI, and the set of weights;
Step 23: END.

FIG. 10c describes an approach for Visualization based on Rel-based Relationship Dimension.

Visualization Based on 3 Relationship Dimensions

Means and Approach for Visualization based on Rel-Based Dimension (1070):
Step 1: Let R be a relation based on which it is required to visualize the EI;
Step 2: Let SR be the set of entity-instances based on UMG DB that satisfy R;
Step 3: Compute Multiple-I-Value based on SR;
Step 4: Set Multiple-I-Value as Rel-Based-I-Value;
Step 5: END.

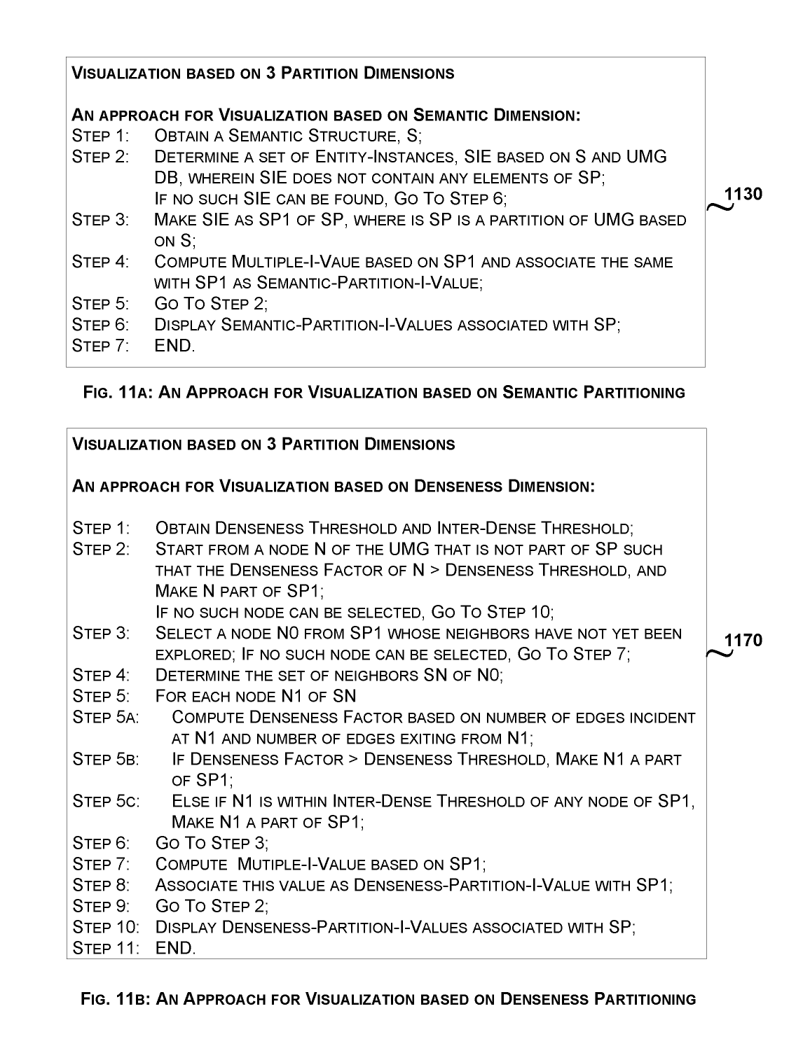

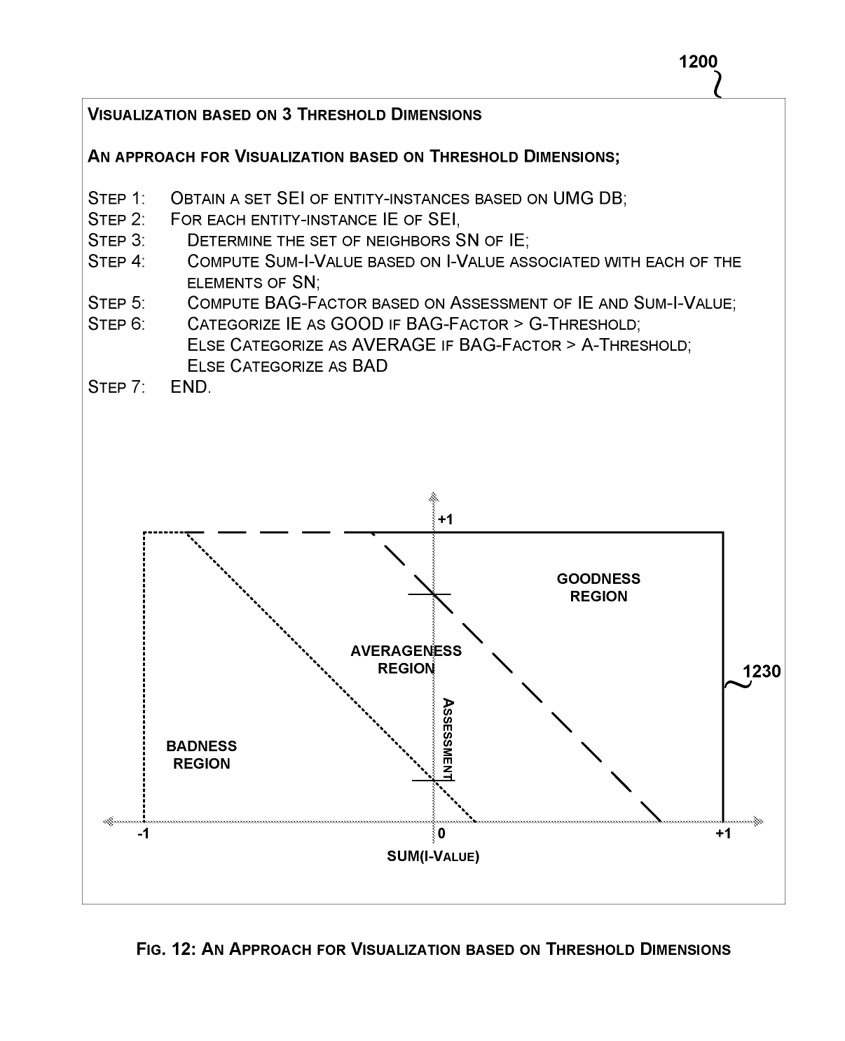

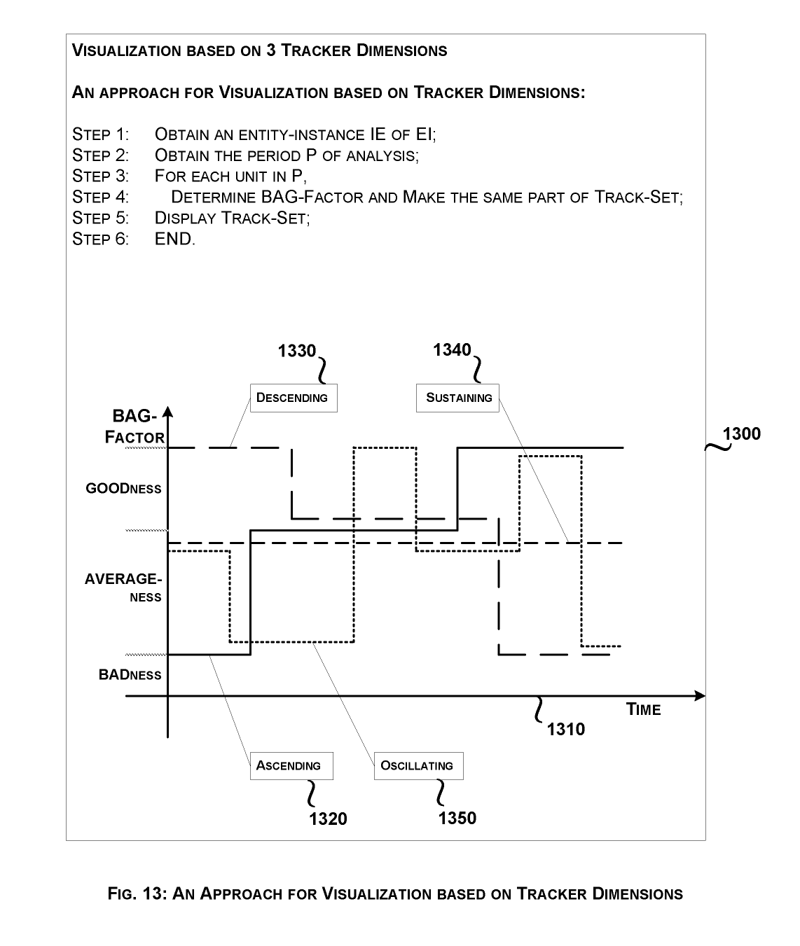

FIG. 11 describes an approach for Visualization based on Syntactic Partitioning.

Visualization Based on 3 Partition Dimensions

3 Partition Dimensions are Syntactic, Semantic, and Denseness-Based;

Means and Approach for Visualization Based on Syntactic Dimension (1100):
Step 1: Define a Syntactic threshold, say, based on nearness criterion;
Step 2: Start from a node N of the UMG that is not part of SP, and Make N part of SP1; If no such node can be selected, Go To Step 9;
Step 3: Select a node NO from SP1 whose neighbors has not yet been explored; If no such node can be selected, Go To Step 7;
Step 4: Determine the set of neighbors SN of NO;
Step 5: For each neighbor N1 of SN,
Step 5a: With respect to each element IE of SPI,
Step 5a1: Compute II-Value between N1 and IE, wherein II-Value is I-Value if N and IE are neighbors in UMG, Or is a derived value based on product of the I-Values associated with the edges of the paths between N1 and IE;
Step 5a2: If II-Value>Syntactic Threshold, Make N1 a part of SN
Step 6: Go To Step 3;
Step 7: Make SP1 a part of SP;
Step 8: Go to Step 2;
Step 9: For each SP1 of SP,
Step 9a: Compute Multiple-I-Value based on SP1;
Step 9b: Associate this value as Syntactic-Partition-I-Value with SP1;
Step 10: Display Syntactic-Partition-I-Values associated with SP;
Step 11: END.

FIG. 11a describes an approach for Visualization based on Semantic Partitioning.

Visualization Based on 3 Partition Dimensions

Means and Approach for Visualization Based on Semantic Dimension (1130):
Step 1: Obtain a Semantic Structure, S;
Step 2: Determine a set of Entity-Instances, SIE based on S and UMG DB, wherein SIE does not contain any elements of SP; If no such SIE can be found, Go To Step 6;
Step 3: Make SIE as SP1 of SP, where is SP is a partition of UMG based on S;
Step 4: Compute Multiple-I-Value based on SP1 and associate the same with SP1 as Semantic-Partition-I-Value;
Step 5: Go To Step 2;
Step 6: Display Semantic-Partition-I-Values associated with SP;
Step 7: END.

FIG. 11b describes an approach for Visualization based on Denseness Partitioning.

Visualization Based on 3 Partition Dimensions

Means and Approach for Visualization Based on Denseness Dimension (1170):
Step 1: Obtain Denseness Threshold and Inter-Dense Threshold;
Step 2: Start from a node N of the UMG that is not part of SP such that the Denseness Factor of N>Denseness Threshold, and Make N part of SP1; If no such node can be selected, Go To Step 10;
Step 3: Select a node NO from SP1 whose neighbors have not yet been explored; If no such node can be selected, Go To Step 7;
Step 4: Determine the set of neighbors SN of NO;
Step 5: For each node N1 of SN
Step 5a: Compute Denseness Factor based on number of edges incident at N1 and number of edges exiting from N1;
Step 5b: If Denseness Factor>Denseness Threshold, Make N1 a part of SP1;
Step 5c: Else if N1 is within Inter-Dense Threshold of any node of SP1, Make N1 a part of SP1;
Step 6: Go To Step 3;
Step 7: Compute Multiple-I-Value based on SP1;
Step 8: Associate this value as Denseness-Partition-I-Value with SP1;
Step 9: Go To Step 2;
Step 10: Display Denseness-Partition-I-Values associated with SP;
Step 11: END.

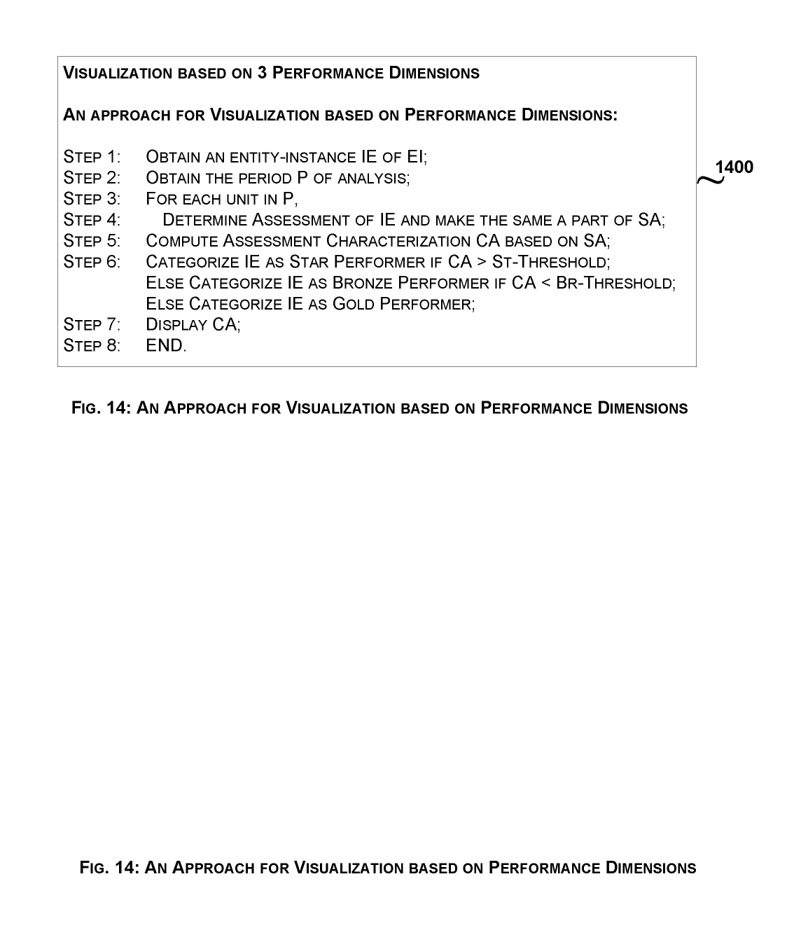

FIG. 12 describes an approach for Visualization based on Threshold Dimensions.

Visualization Based on 3 Threshold Dimensions

Means and Approach for Visualization Based on Threshold Dimensions (1200):
Step 1: Obtain a set SEI of entity-instances based on UMG DB;
Step 2: For each entity-instance IE of SEI,
Step 3: Determine the set of neighbors SN of IE;
Step 4: Compute Sum-I-Value based on I-Value associated with each of the elements of SN;
Step 5: Compute BAG-Factor based on Assessment of IE and Sum-I-Value;
Step 6: Categorize IE as GOOD if BAG-Factor>G-Threshold; Else Categorize as AVERAGE if BAG-Factor>A-Threshold; Else Categorize as BAD
Step 7: END.

1230 provides an illustrative visualization of UMG data based on threshold dimensions. The X-axis denotes the sum of I-Values and Y-axis denotes the assessment of the entity-instance under consideration. The visualization depicts three regions, namely, Badness region, Averageness region, and Goodness region.

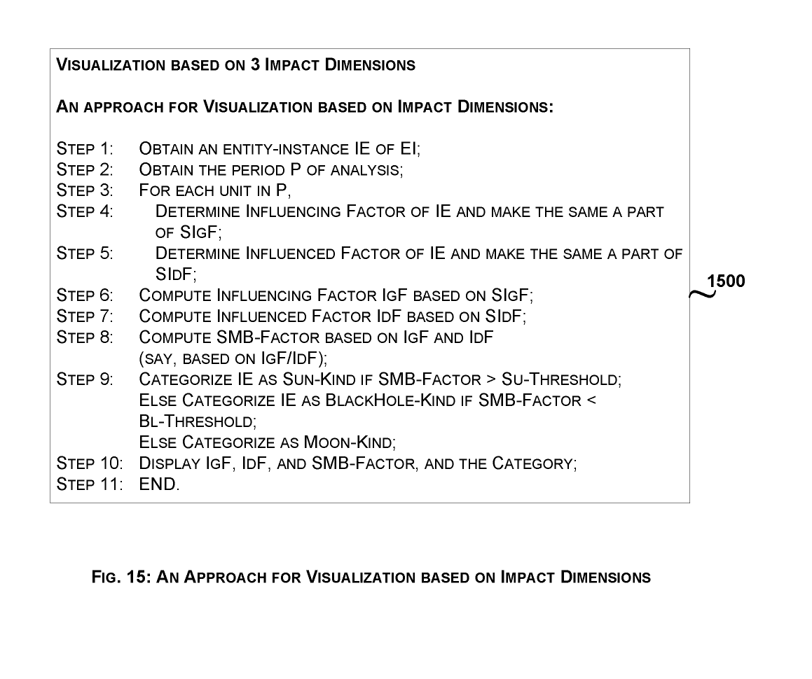

FIG. 13 describes an approach for Visualization based on Tracker Dimensions.

Visualization Based on 3 Tracker Dimensions

Means and Approach for Visualization Based on Tracker Dimensions (1300):
Step 1: Obtain an entity-instance IE of EI;
Step 2: Obtain the period P of analysis;
Step 3: For each unit in P,
Step 4: Determine BAG-Factor and Make the same part of Track-Set;
Step 5: Display Track-Set;
Step 6: END.

1310 provides a depiction of a visualization based on tracker dimensions. X-axis denotes Time while the Y-Axis denotes BAG-Factor. The Bag-Factor computed for an entity-instance over a period of time is visualized along with X-Y axes: 1320 depicts an Ascending Bag-factor while 1330 depicts a Descending one. 1340 shows a Sustaining Bag-factor and 1350 shows an Oscillating characterization of an entity-instance.

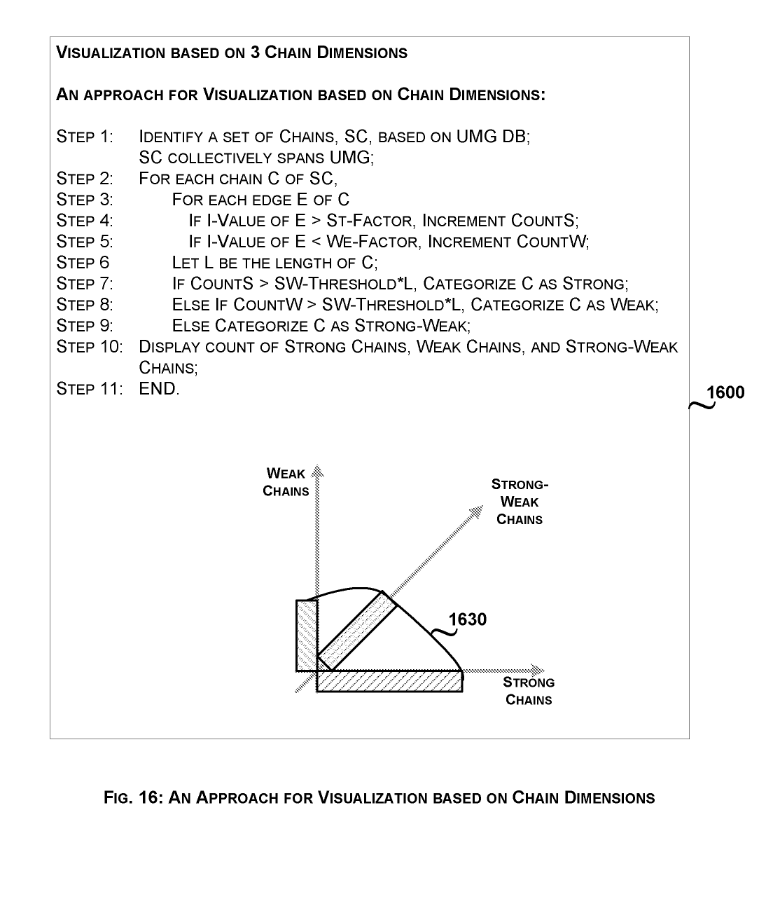

FIG. 14 describes an approach for Visualization based on Performance Dimensions.

Visualization Based on 3 Performance Dimensions

Means and Approach for Visualization Based on Performance Dimensions (1400):
Step 1: Obtain an entity-instance IE of EI;
Step 2: Obtain the period P of analysis;
Step 3: For each unit in P,
Step 4: Determine Assessment of IE and make the same a part of SA;
Step 5: Compute Assessment Characterization CA based on SA;
Step 6: Categorize IE as Star Performer if CA>St-Threshold; Else Categorize IE as Bronze Performer if CA<Br-Threshold; Else Categorize IE as Gold Performer;
Step 7: Display CA;
Step 8: END.

FIG. 15 describes an approach for Visualization based on Impact Dimensions.

Visualization Based on 3 Impact Dimensions

Means and Approach for Visualization Based on Impact Dimensions (1500):
Step 1: Obtain an entity-instance IE of EI;
Step 2: Obtain the period P of analysis;
Step 3: For each unit in P,
Step 4: Determine Influencing Factor of IE and make the same a part of SIgF;
Step 5: Determine Influenced Factor of IE and make the same a part of SIdF;
Step 6: Compute Influencing Factor IgF based on SIgF;
Step 7: Compute Influenced Factor IdF based on SIdF;
Step 8: Compute SMB-Factor based on IgF and IdF (say, based on IgF/IdF);
Step 9: Categorize IE as Sun-Kind if SMB-Factor>Su-Threshold; Else Categorize IE as BlackHole-Kind if SMB-Factor<BI-Threshold; Else Categorize as Moon-Kind;
Step 10: Display IgF, IdF, and SMB-Factor, and the Category;
Step 11: END.

FIG. 16 describes an approach for Visualization based on Chain Dimensions.

Visualization Based on 3 Chain Dimensions

Means and Approach for Visualization Based on Chain Dimensions:
Step 1: Identify a set of Chains, SC, based on UMG DB; SC collectively spans UMG;
Step 2: For each chain C of SC,
Step 3: For each edge E of C
Step 4: If I-Value of E>St-Factor, Increment CountS;
Step 5: If I-Value of E<We-Factor, Increment CountW;
Step 6 Let L be the length of C;
Step 7: If CountS>SW-Threshold*L, Categorize C as Strong;
Step 8: Else If CountW>SW-Threshold*L, Categorize C as Weak;
Step 9: Else Categorize C as Strong-Weak;
Step 10: Display count of Strong Chains, Weak Chains, and Strong-Weak Chains;
Step 11: END.

1630 depicts a visualization based on chain dimension. Here, X-axis denotes Strong Chains while Y-axis denotes Weak Chains; The count of chains that are neither comprehensively strong nor comprehensively weak is denoted along an axis in between X-axis and Y-axis as depicted.

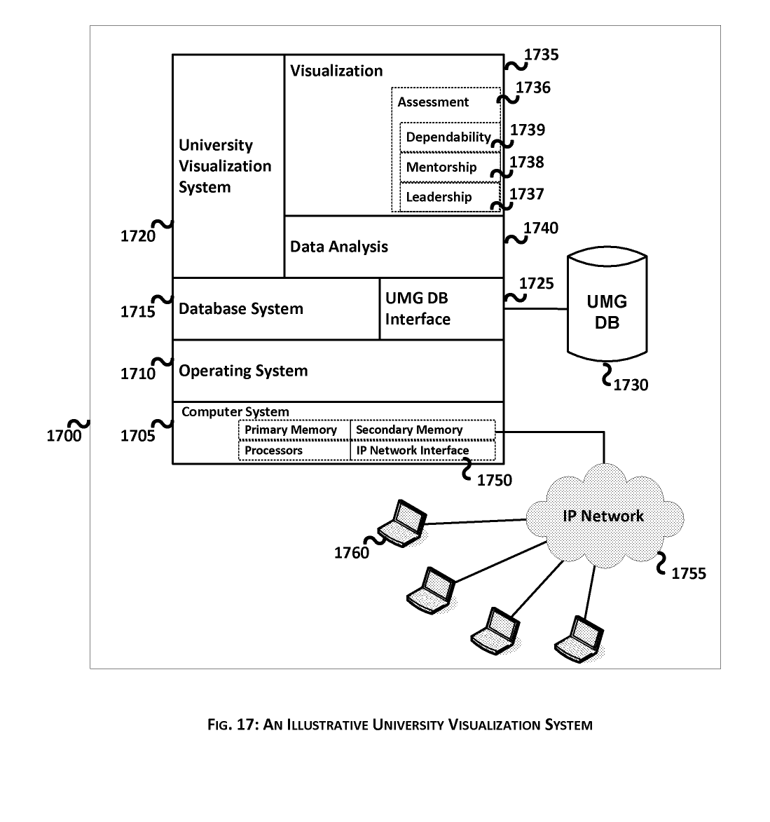

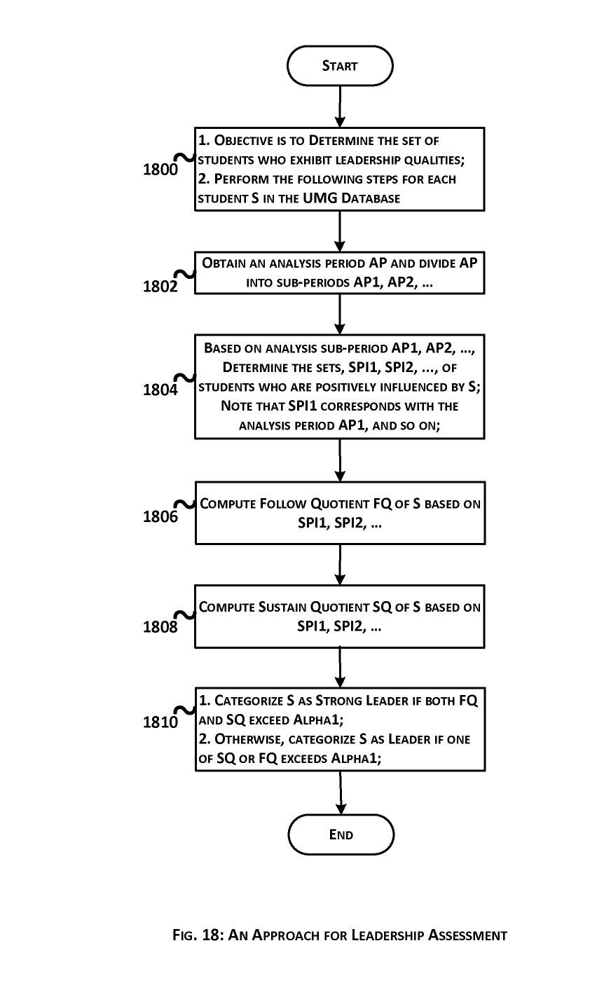

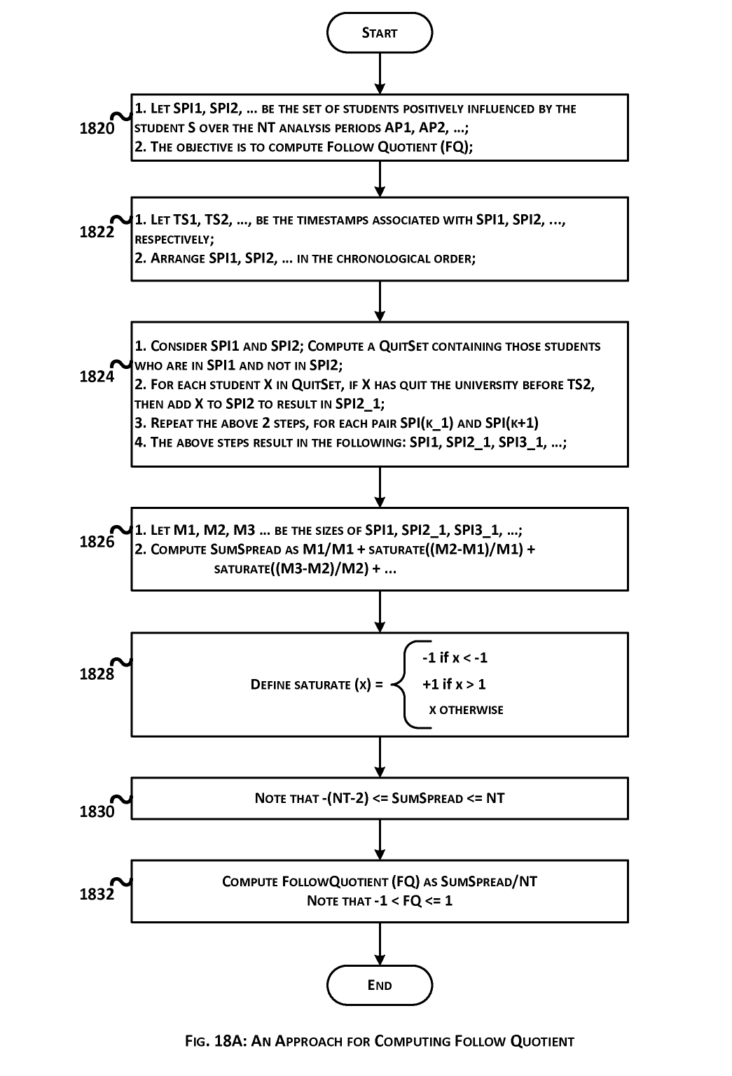

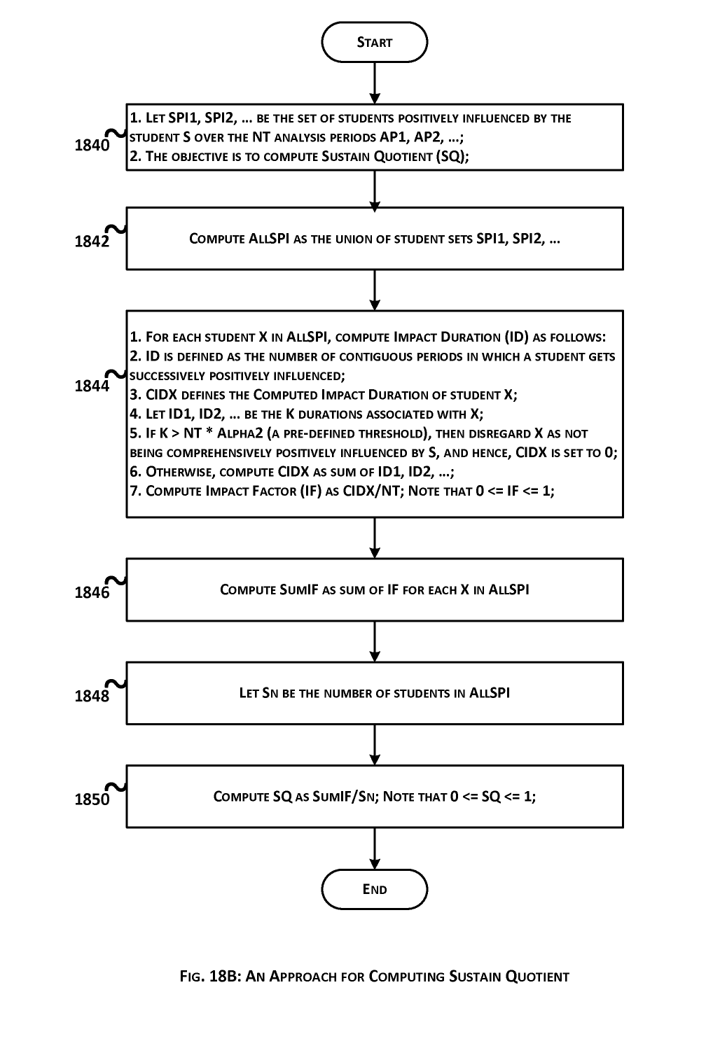

FIG. 17 provides an illustrative elaboration (1700) of University Visualization System. In a preferred embodiment, the University Visualization System (1720) is realized on a computer system (1705) with several processors, primary memory units, secondary memory units, and network interfaces, and with an operating system (1710) and a database system (1715). The database system in particular comprises of a component University Model Graph (UMG) DB (database) Interface (1725) to help access University Model Graph (UMG) database (1730). As depicted in the figure, the University Visualization System comprises of two key components, namely, Visualization Component (1735) and Data Analysis Component (1740). The Data Analysis component helps in retrieving and analyzing of the required data elements from the UMG Database while the Visualization component helps visualize UMG database related to the students of the university in terms of their leadership, mentorship, and dependability aspects and this achieved using three assessment (1736) sub-components related to Leadership (1737), Mentorship (1738),and Dependability (1739).

Note that in a preferred embodiment, the University Visualization System helps analyze the data associated with a set of students of a university to identify a set of strong leaders, a set of leaders, a set of mentors, and a set of dependable students. Here, a student of the set of strong leaders is the student categorized as a strong leader, a student of the set of leaders is the student categorized as a leader, a student of the set of mentors is the student categorized as a mentor, and a student of the set of dependable students is the student categorized as a dependable student.

The IP Network Interface (1750) is used to connect the computer system to an Internet Protocol (IP) Network (1755) so that several users (1760) can connect and interact with the University Visualization System through the Internet or an intranet.

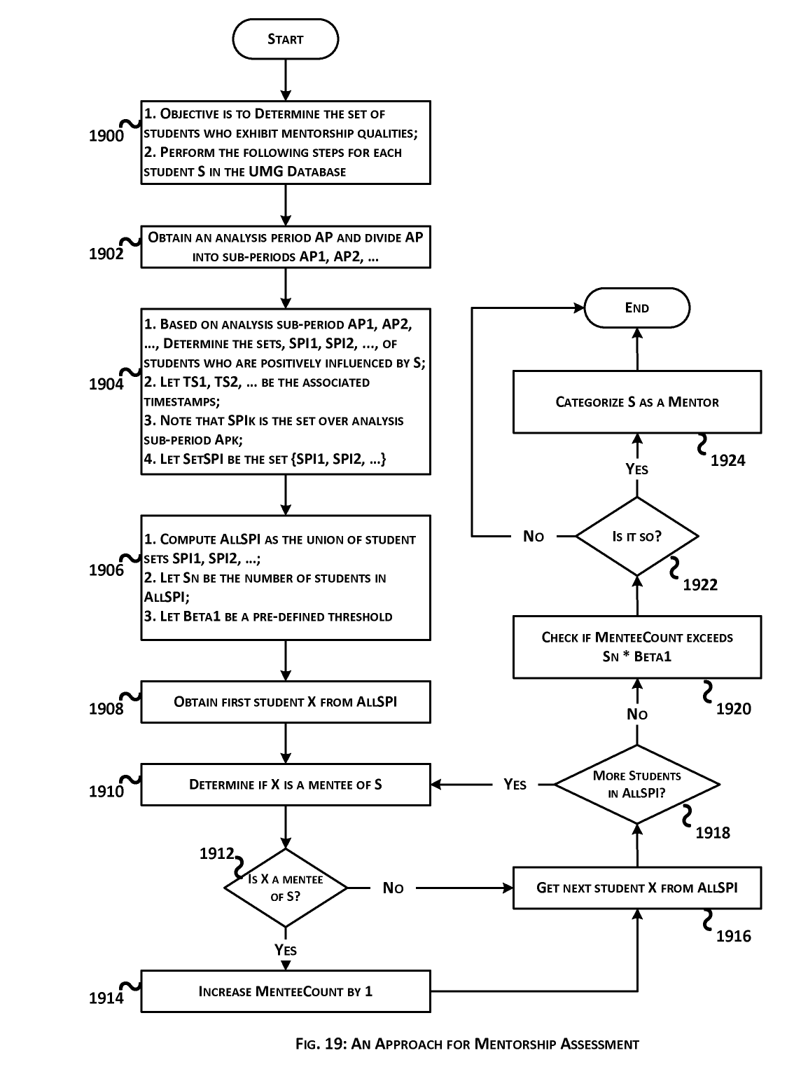

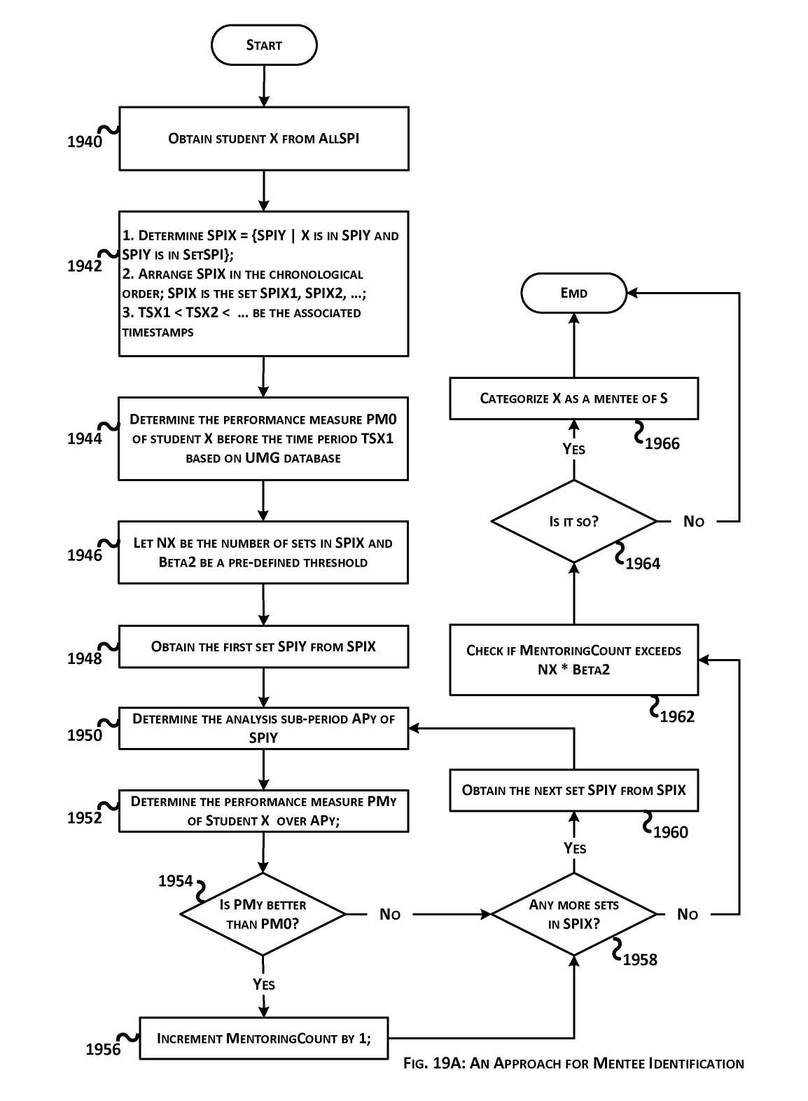

FIG. 18 depicts an approach for Leadership Assessment.

The objective is to determine the set of students who exhibit leadership qualities (1800) and a particular visualization of UMG database from the point of view of students is to depict their leadership capabilities. Perform the following steps for each student S in the UMG Database so as to determine the nature of leadership abilities in the students.

Obtain an analysis period AP and divide AP into sub-periods AP1, AP2, . . . (1802). In order to analyze data related to the student S, the analysis is carried at various sub-periods and such an approach provides an opportunity to determine the changing leadership qualities exhibited by the student over the analysis period AP.

Based on analysis sub-period AP1, AP2, . . . , determine the sets, SPI1, SPI2, . . . , of students who are positively influenced by S (1804). Note that SPI1 is a set of students who are positively influenced by S and corresponds with the analysis period AP1, and so on.

Also note that SP1 is determined based on UMG database wherein positive influence values are associated with the directed edges from the node designating the student S and the nodes that correspond with the students part of SPI1.

The leadership qualities of the student S are assessed based on the ability of the student to positively influence other students. Hence, SPI1 is determined to contain those students who are positively influenced by S during the analysis sub-period AP1.

The leadership capabilities are identified by determining two quotients: the first quotient is called as Follow Quotient (FQ): this indicates whether the student can keep positively influencing other students; in other words, in such a case, it is expected that the number of students positively influenced by S should increase with time. The second quotient is called as Sustain Quotient (SQ) that captures the notion that if a student is positively influenced by S, then the student gets positively influenced subsequently as well.

Compute Follow Quotient FQ of S based on SPI1, SPI2, . . . (1806). This computation is further elaborated below.

Compute Sustain Quotient SQ of S based on SPI1, SPI2, . . . (1808). This computation is also further elaborated below.

The leadership capabilities are based on the computed FQ and SQ values (1810). Let Alpha1 be a pre-defined threshold between 0 and 1 (say, a value of 0.5). Note that 0<=FQ<=1 and 0<=SQ<=1.

Categorize the student S as Strong Leader if both FQ and SQ exceed Alpha1;

Otherwise, categorize S as Leader if one of SQ or FQ exceeds Alpha1;

FIG. 18A provides an approach for computing Follow Quotient.

Let SPI1, SPI2, . . . be the set of students positively influenced by the student S over the NT analysis periods AP1, AP2, . . . (1820). The objective is to compute Follow Quotient (FQ) of S.

Let TS1, TS2, . . . , be the timestamps associated with SPI1, SPI2, . . . , respectively (1822). Arrange SPI1, SPI2, . . . in the chronological order.

The following steps help extend SPI2, SPI3, . . . optimistically by incorporating those positively influenced students who have quit the university (1824).

1. Consider SPI1 and SPI2; Compute a QuitSet containing those students who are in SPI1 and not in SPI2;

2. For each student X in QuitSet, if X has quit the university before TS2, then add X to SPI2 to result in SPI2_1;

3. Repeat the above 2 steps, for each pair SPI(k_1) and SPI(k+1); and

4. The above steps result in the following sets: SPI1, SPI2_1, SPI3_1, . . . .

Let M1, M2, M3 . . . be the sizes of SPI1, SPI2_1, SPI3_1, . . . respectively (1826).

Compute SumSpread as (M1/M1)+saturate((M2−M1)/M1)+saturate((M3−M2)/M2)+ . . . .

SumSpread indicates how effectively the student S has positively influenced the other students over the analysis period AP.

The saturate function used above is defined as follows (1828): saturate (x) is −1 if x is <−1, is +1 if x is >+1, or is x otherwise (1828).

Note that Note that −(NT−2)<=SumSpread<=(NT) (1830).

Finally, compute FollowQuotient (FQ) as SumSpread/NT (1832) and note that −1<FQ<=1.

FIG. 18B provides an approach for computing Sustain Quotient.

Let SPI1, SPI2, . . . be the set of students positively influenced by the student S over the NT analysis periods AP1, AP2, . . . (1840). The objective is to compute Sustain Quotient (SQ).

Compute AIISPI as the union of student sets SPI1, SPI2, . . . (1842). Note that AIISPI contains a set of students who are positively influenced by the student S at least in one analysis sub-period.

For each student X in AIISPI, compute Impact Duration (ID) as follows (1844):

1. ID is defined as the number of contiguous periods in which a student gets successively positively influenced;

2. CIDX defines the Computed Impact Duration of student X;

3. Let ID1, ID2, . . . be the K durations associated with X;

4. If K>NT*Alpha2 (a pre-defined threshold between 0 and 1, say 0.5), then disregard X as not being comprehensively positively influenced by S, and hence, CIDX is set to 0;

5. Otherwise, compute CIDX as sum of ID1, ID2, . . . ; and

6. Compute Impact Factor (IF) as CIDX/NT; Note that 0<=IF<=1.

Compute SumIF as sum of IF for each X in AIISPI (1846). Note that it is required to determine the sustained positive influence of S across a population of students.

Let Sn be the number of students in AIISPI (1848).

Compute SQ as SumIF/Sn (1850) and note that 0<=SQ<=1.

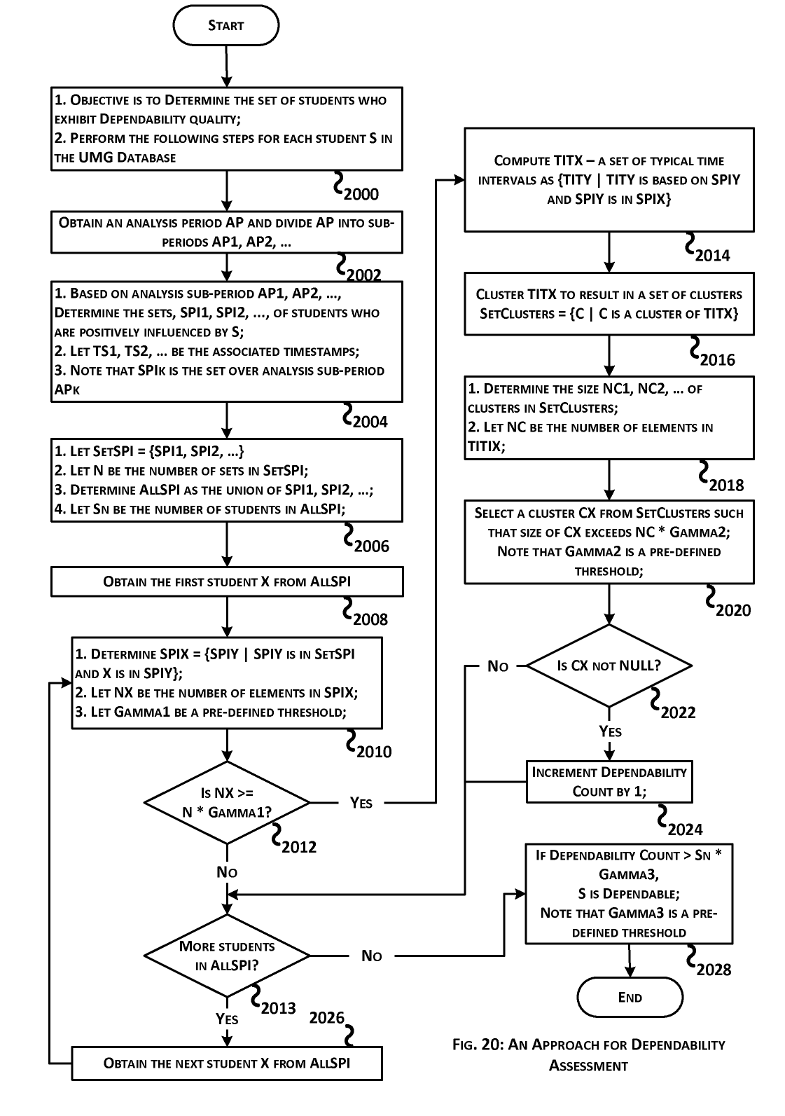

FIG. 19 depicts an approach for Mentorship Assessment.

The objective is to determine the set of students who exhibit mentorship qualities (1900).

Mentorship abilities are determined based on whether there has been improvement in the performance of a student when the student was consistently positively influenced by the student S.

Perform the following steps for each student S in the UMG Database to determine the mentorship abilities of the students.

Obtain an analysis period AP and divide AP into sub-periods AP1, AP2, . . . (1902).

Based on analysis sub-period AP1, AP2, . . . , determine the sets, SPI1, SPI2, . . . , of students who are positively influenced by S (1904). Let TS1, TS2, . . . be the associated timestamps. Note that SPIk is the set over analysis sub-period APk. Let SetSPI be the set {SPI1, SPI2, . . . }.

Compute AIISPI as the union of student sets SPI1, SPI2, . . . (1906). Let Sn be the number of students in AIISPI and let Beta1 be a pre-defined threshold (a value between 0 and 1, say 0.5).

Obtain first student X from AIISPI (1908).

Determine if X is a mentee of S (1910). This mentee determination is further elaborated below.

Check if X is a mentee of S (1912). If so, increase MenteeCount by 1 (1914) and proceed to Step 1916.

If it is not so (1912), get next student X from AIISPI (1916).

Check if there are more students in AIISPI to be processed (1918).

If so, proceed to Step 1910.

If is not so (1918), check if MenteeCount exceeds Sn*Beta1 (1920).

If it is so (1922), categorize S as a Mentor (1924).

If it is not so (1922), the student S does not exhibit the mentorship abilities.

FIG. 19A provides an approach for Mentee identification.

Obtain student X from AIISPI (1940).

Determine SPIX={SPIY|X is in SPIY and SPIY is in SetSPI} (1942). Note that SPIX contains all the sets of SetSPI in which X is present. Arrange SPIX in the chronological order and the arranged SPIX is the set SPIX1, SPIX2, . . . . Let TSX1<TSX2< . . . be the associated timestamps.

Determine the performance measure PM0 of student X before the time period TSX1 based on UMG database (1944). Note that the performance measure of the student X is nothing but the assessment associated with the node that corresponds with the student X as per the UMG database.

Let NX be the number of sets in SPIX (1946) and Beta2 be a pre-defined threshold (a value between 0 and 1, say 0.5).

Obtain the first set SPIY from SPIX (1948).

Determine the analysis sub-period APy of SPIY (1950).

Determine the performance measure PMy of Student X over APy (1952).

Check if PMy is better than PM0 (1954).

If it is so, increment MentoringCount by 1 (1956) and proceed to Step 1958.

If it is not so (1954), check if there are more sets in SPIX that are yet to be processed (1958).

If so (1958), obtain the next set SPIY from SPIX (1960) and proceed to Step 1950.

If it is not so (1958), check if MentoringCount exceeds NX*Beta2 (1962).

If it is so (1964), categorize X as a mentee of S (1966).

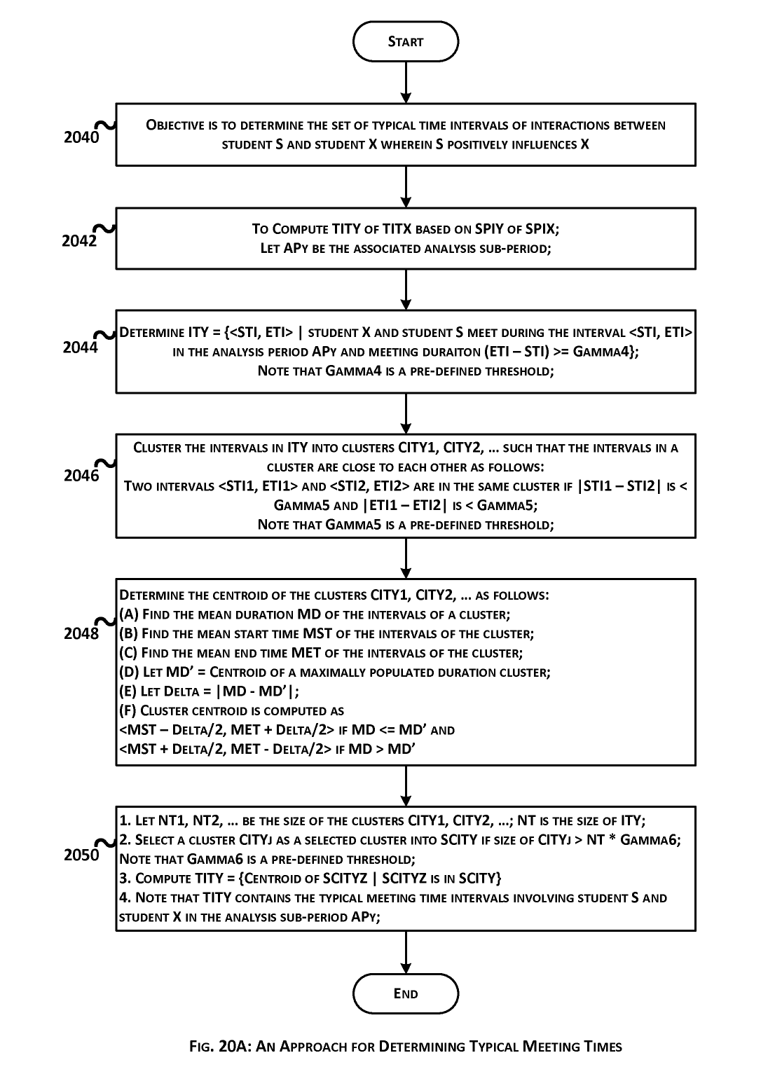

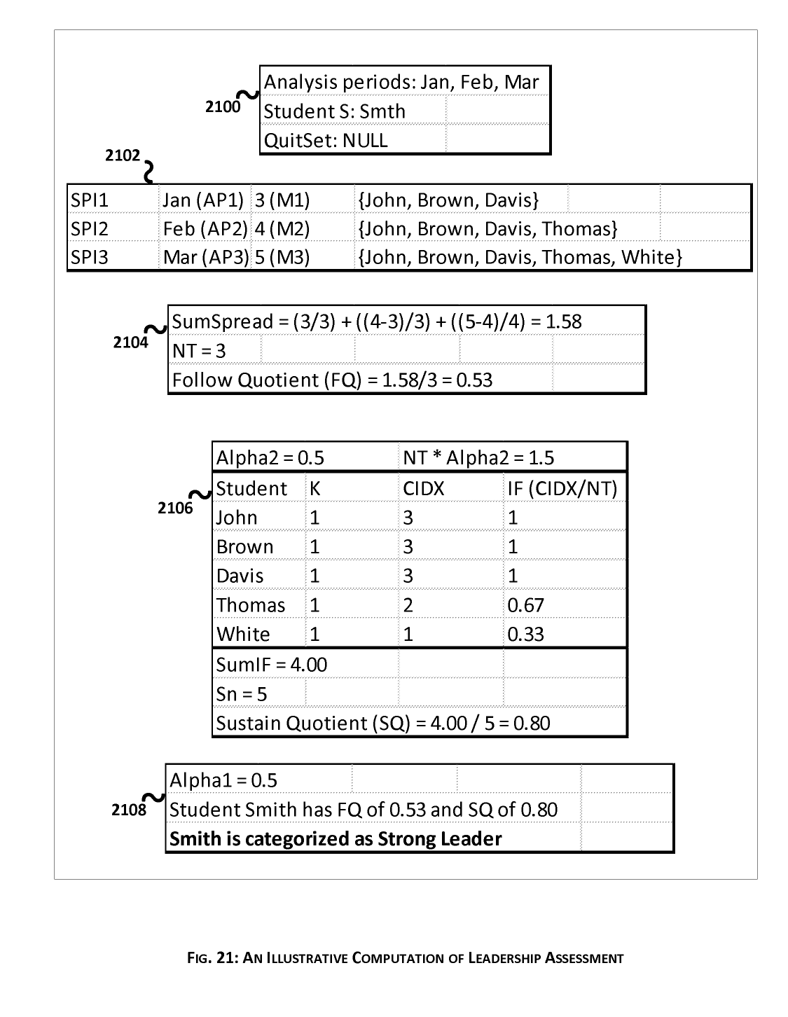

FIG. 20 depicts an approach for Dependability Assessment.

The objective is to determine the set of students who exhibit dependability quality (2000). One of the ways to measure this aspect is based on the interaction regularity. Perform the following steps for each student S in the UMG Database in order to determine their dependability characteristics. Obtain an analysis period AP and divide AP into sub-periods AP1, AP2, . . . (2002).

Based on analysis sub-period AP1, AP2, . . . , determine the sets, SPI1, SPI2, . . . , of students who are positively influenced by S (2004). Let TS1, TS2, . . . be the associated timestamps and note that SPIk is the set over the analysis sub-period APk

Let SetSPI={SPI1, SPI2, . . . } (2006) and let N be the number of sets in SetSPI. Determine AIISPI as the union of SPI1, SPI2, . . . and let Sn be the number of students in AIISPI.

Obtain the first student X from AIISPI (2008).

Determine SPIX={SPIY|SPIY is in SetSPI and X is in SPIY} (2010) and let NX be the number of elements in SPIX. Let Gamma1 be a pre-defined threshold (a value between 0 and 1, say 0.7).

Check if NX>=N*Gamma1 (2012).

If it so, compute TITX a set of typical time intervals as {TITY|TITY is based on SPIY and SPIY is in SPIX} (2014). The approach establishes the interaction regularity by identifying typical meeting times in each of the analysis sub-periods and by correlating the same across multiple analysis sub-periods. Cluster TITX to result in a set of clusters: SetClusters={C|C is a cluster of TITX} (2016).

Determine the size NC1, NC2, . . . of clusters in SetClusters and let NC be the number of elements in TITIX (2018).

Select a cluster CX from SetClusters such that size of CX exceeds NC*Gamma2 (2020). Note that Gamma2 is a pre-defined threshold (a value between 0 and 1, say 0.5).

Check if CX is not NULL (2022).

If it is so, increment Dependability Count by 1 (2024) and proceed to Step 2013.

If it is not so (2022), proceed to Step 2013.

If it is not so (2012), proceed to Step 2013.

Check if there are more students in AIISPI who are yet to be processed (2013).

If so, obtain the next student X from AIISPI (2026) and proceed to Step 2010.

If it is not so (2013), then the processing is completed with respect to the student S and if Dependability Count>Sn*Gamma3, then categorize S as Dependable (2028). Note that Gamma3 is a pre-defined threshold with a value between 0 and 1 (say 0.3).

FIG. 20A provides an approach for determining typical Meeting Times.

The objective is to determine a set of typical time intervals of interactions between student S and student X wherein S positively influences X (2040).

It is required to compute TITY of TITX based on SPIY of SPIX and let APy be the associated analysis sub-period (2042).

Determine ITY={<STI, ETI>| student X and student S meet during the interval<STI, ETI> in the analysis sub-period APy and meeting duration (ETI−STI)>=Gamma4} (2044). Note that Gamma4 is a pre-defined threshold (say, 15).

Cluster the intervals in ITY into clusters CITY1, CITY2, . . . such that the intervals in a cluster are close to each other as follows (2046):

Two intervals <STI1, ETI1> and <STI2, ETI2> are in the same cluster if |STI1−STI2| is <Gamma5 and |ETI1−ETI2| is <Gamma5; Note that Gamma5 is a pre-defined threshold (say, 45).

Determine the centroid of the clusters CITY1, CITY2, . . . as follows (2048):

(A) Find the mean duration MD of the intervals of a cluster;

(B) Find the mean start time MST of the intervals of the cluster;

(C) Find the mean end time MET of the intervals of the cluster;

(D) Let MD′=Centroid of a maximally populated duration cluster;

(E) Let Delta=|MD−MD′|;

(F) Cluster centroid is computed as

<MST−Delta/2, MET+Delta/2> if MD<=MD′ and

<MST+Delta/2, MET−Delta/2> if MD>MD′.

Let NT1, NT2, . . . be the size of the clusters CITY1, CITY2, . . . ; NT is the size of ITY (2050).

Select a cluster CITYj as a selected cluster into SCITY if size of CITYj>NT*Gamma6 and note that Gamma6 is a pre-defined threshold (a value between 0 and 1, say 0.5).

Compute TITY={Centroid of SCITYZ|SCITYZ is in SCITY}.

Note that TITY contains the typical meeting time intervals involving student S and student X in the analysis sub-period APy.

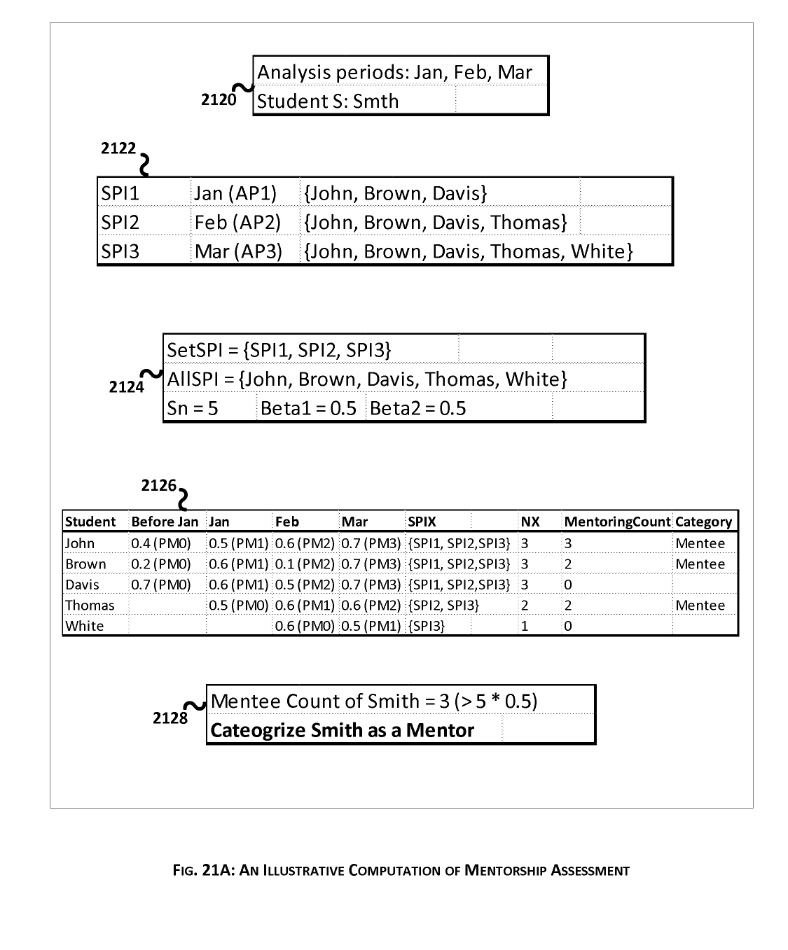

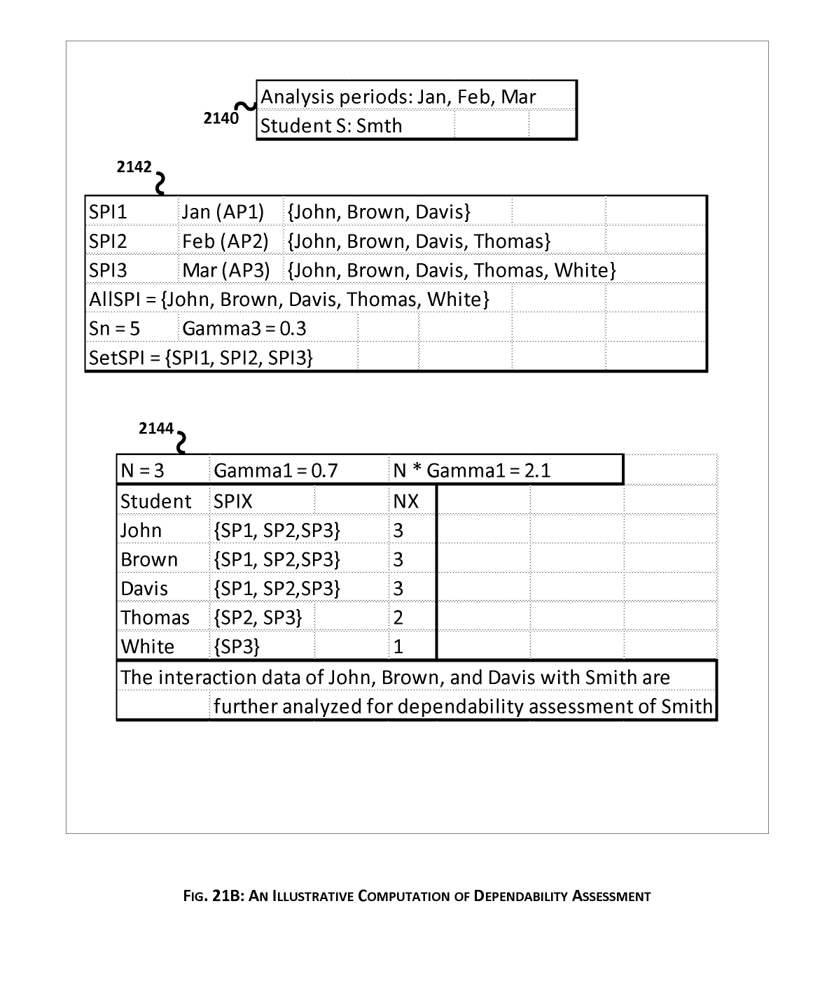

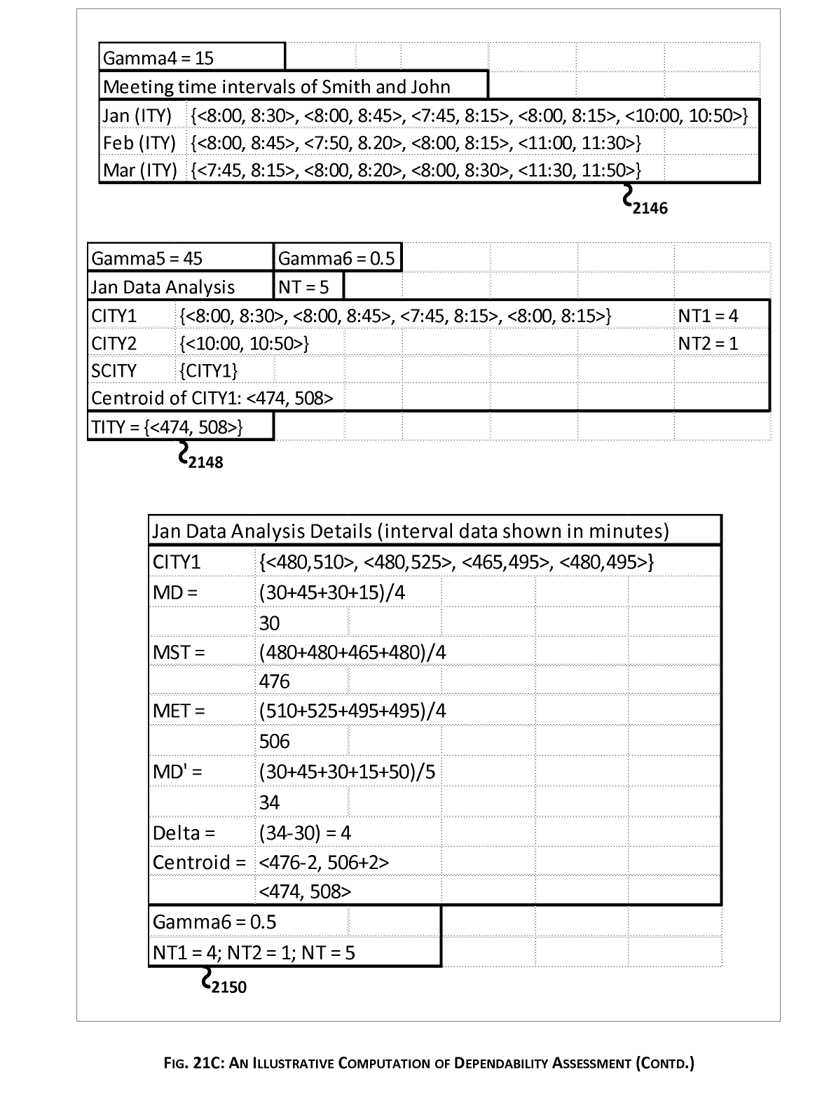

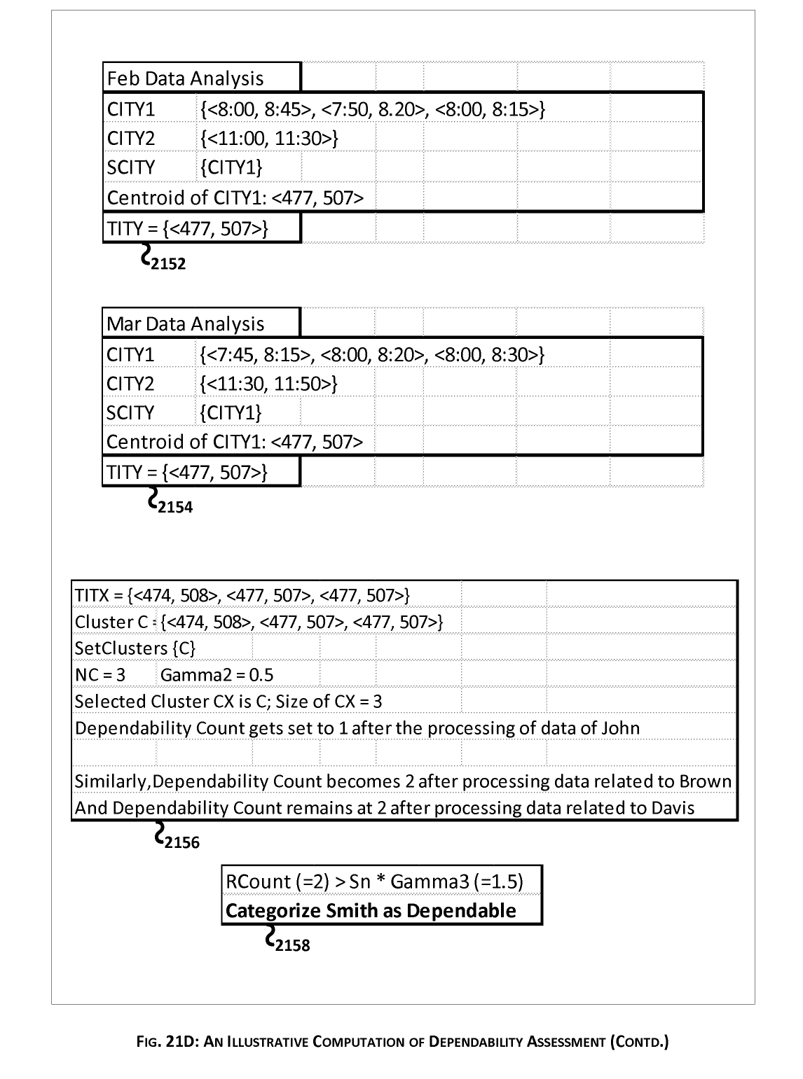

FIG. 21 provides an illustrative computation of Leadership Assessment.

Step 2100 depicts that the analysis sub-periods are January, February, and March with respect to the student Smith (S) and QuitSet is assumed to be NULL for all cases.

Step 2102 depicts the sets SPI1, SPI2 and SPI3 with their analysis sub-periods and the counts.

Step 2104 depicts the computation of SumSpread as 1.58 and Follow Quotient (FQ) as 0.53.

Step 2106 depicts the computation of Impact Factor with respect to the various students positively influenced by Smith and SumIF is computed as 4.0 to result in the Sustain Quotient (SO) of 0.80.

Finally, Step 2108 depicts the leadership categorization of Smith as a strong leader.

FIG. 21A provides an illustrative computation of Mentorship Assessment.
Step 2120 depicts that the analysis sub-periods are January, February, and March with respect to the student Smith.

Step 2122 depicts the sets SPI1, SPI2 and SPI3 with their analysis sub-periods.

Step 2124 depicts the computation of SetSPI, AIISPI, and Sn.

Step 2126 depicts the computation of MentoringCount to categorize the various students who are positively influenced by Smith as Mentee and observe that three students are categorized as Mentee.

Finally, Step 2128 depicts the mentorship categorization of Smith as a Mentor.

FIG. 21B provides an illustrative computation of Dependability Assessment.
Step 2140 depicts that the analysis sub-periods are January, February, and March with respect to the student Smith.

Step 2142 depicts the sets SPI1, SPI2 and SPI3 with their analysis sub-periods along with the computation of AIISPI, SetSPI, and Sn.

Step 2144 depicts the computation of SPIX with respect to the various students who are positively influenced by Smith and the selection of three students John, Brown, and Davis whose data are to be further analyzed.

FIG. 21C provides additional information related to the illustrative computation of Dependability Assessment.
Step 2146 depicts the meeting time intervals involving the students Smith and John.

Step 2148 depicts the analysis January meeting time intervals data and the analysis results in the computation of two clusters CITY1 and CITY2 with CITY1 being part of SCITY. The Step further depicts the computation of centroid of CITY1 and making the same as part of TITY.

Step 2150 shows the computation of MD, MST, MET, MD′, Delta, and Centroid based on January data of meeting time intervals involving Smith and John.

FIG. 21D provides some more information related to the illustrative computation of Dependability Assessment.

Step 2152 details the analysis of February data resulting in the computation of TITY. And similarly, Step 2154 details the analysis of March data resulting in the computation of TITY.

Step 2156 depicts TITX, computation of clusters of elements of TITX (in this case just one cluster C), and making C a part of SetClusters. Based on NC and Gamma2, C becomes part of CX. At the end of the processing of January data, Dependability Count gets set to 1.

Similar processing of February and March data results in Dependability Count becoming 2.

Finally, Step 2158 categorizes Smith as Dependable based on Dependability Count (=2) and Sn*Gamma3 (=1.5).

Thus, a system and method for the visualization based on a university model graph of a university is disclosed. Although the present invention has been described particularly with reference to the figures, it will be apparent to one of the ordinary skill in the art that the present invention may appear in any number of systems that provide visualization of influence based structural representation. It is further contemplated that many changes and modifications may be made by one of ordinary skill in the art without departing from the spirit and scope of the present invention.

We claim:

1. A computer-implemented method for visualizing a plurality of students of an educational institution as a plurality of strong leaders, a plurality of leaders, a plurality of mentors, and a plurality of dependable students using a structural representation of said educational institution in the form of a university model graph comprising a plurality of assessments and a plurality of influence values based on a university model graph (UMG) database and said plurality of students of said educational institution,
said method performed on a computer system comprising at least one processor, one or more memory units, and one or more network interfaces for connecting said computer system to an Internet Protocol (IP) network, said method comprising the steps of:
determining, with at least one processor, a first student (S) of said plurality of students;
determining, with at least one processor, an analysis period (AP);
determining, with at least one processor, a plurality of analysis sub-periods based on said AP;
computing, with at least one processor, a number of analysis sub-periods (NT) based on said plurality of analysis sub-periods;
determining, with at least one processor, a positively influenced student set of a plurality of positively influenced student sets based on said plurality of students, said S, an analysis sub-period of said plurality of analysis sub-periods, said plurality of influence values, and said UMG database;
computing, with at least one processor, a plurality of all set positively influenced students, wherein a student of said plurality of all set positively influenced students is part of said plurality of students and a member of a positively influenced student set of said plurality of positively influenced student sets;
computing, with at least one processor, a number of students (Sn) in said plurality of all set positively influenced students;
computing, with at least one processor, a number of sets (N) in said plurality of positively influenced student sets;
computing, with at least one processor, a follow quotient (FQ) of said S based on said plurality of positively influenced student sets;
computing, with at least one processor, a sustain quotient (SO) of said S based on said plurality of positively influenced student sets;
making, with at least one processor, said S a part of said plurality of strong leaders, wherein said FQ exceeds a first pre-defined threshold (alpha1) and said SQ exceeds said alpha1;
making, with at least one processor, said S a part of said plurality of leaders, wherein said FQ exceeds said alpha1 or said SQ exceeds said alpha1;
computing, with at least one processor, a mentee count based on said plurality all set positively influenced students and said plurality of positively influenced student sets;
making, with at least one processor, said S a part of said plurality of mentors, wherein said mentee count exceeds said Sn* a second pre-defined threshold (beta1);
computing, with at least one processor, a dependability count based on said plurality all set positively influenced students and said plurality of positively influenced student sets; and
making, with at least one processor, said S a part of said plurality of dependable students, wherein said dependability count exceeds said Sn* a third pre-defined threshold (gamma3).

2. The method of claim 1, wherein said step for computing said FQ further comprising the steps of:
arranging said plurality of positively influenced student sets chronologically to result in a plurality of ordered positively influenced student sets;
selecting a first positively influenced student set of said plurality of ordered positively influenced student sets;
selecting a next positively influenced student set of said plurality of ordered positively influenced student sets and said first positively influenced student set;
determining a plurality of first positively influenced students based on said first positively influenced student set, wherein a first positively influenced student of said plurality of first positively influenced students is a member of said first positively influenced student set;
determining a plurality of next positively influenced students based on said next positively influenced student set, wherein a next positively influenced student of said plurality of next positively influenced students is a member of said next positively influenced student set;
determining a plurality of quit students, wherein a student of said plurality of quit students is a part of said plurality of first positively influenced students and not a part of said plurality of next positively influenced students;
making a student of said plurality of quit students a part of a plurality of modified next positively influenced students, wherein said student has quit said educational institution before a second time, wherein said second time is the time associated with said plurality of next positively influenced students;
determining a modified next positively influenced student set of a plurality of modified positively influenced student sets based on said plurality of modified next positively influenced students, wherein a modified next positively influenced student of said plurality of modified next positively influenced students is a member of said modified next positively influenced student set;
computing a plurality of modified sizes of said plurality of modified positively influenced student sets, wherein a modified size of said plurality of modified sizes is the size of a modified positively influenced student set of said plurality of modified positively influenced student sets;
determining a first modified size (M1) of said plurality of modified sizes;
determining a second modified size (M2) of said plurality of modified sizes;
determining a third modified size (M3) of said plurality of modified sizes;
computing a first summand (S1) as said M1/said M2;
computing a second summand (S2) as a saturated value of a result of ((said M2−said M1)/said M1), wherein said saturated value is −1 if said result is less than −1, +1 if said result is greater than +1, or said result;
computing a third summand (S3) as a saturated value of a result of ((said M3−said M2)/said M2), wherein said saturated value is −1 if said result is less than −1, +1 if said result is greater than +1, or said result;
computing a sum spread based on said S1, said S2, said S3, and said plurality of modified sizes; and
computing said FQ as said sum spread/said NT.

3. The method of claim 1, wherein said step for computing said SQ further comprising the steps of:
determining a student (X) of said plurality of all set positively influenced students;
computing a plurality of impact durations based on said X and said plurality of positively influenced student sets, wherein an impact duration of said plurality of impact durations is the number of a plurality of contiguous sets of said plurality of positively influenced student sets, wherein said X is a member of each of said plurality of contiguous sets;
computing a number of durations (K) based on said plurality of impact durations;
setting a computed impact duration (CIDX) as zero, wherein said K exceeds said NT* a fourth pre-defined threshold (alpha2);
computing said CIDX of said X by summing said plurality of impact durations, wherein said K is less than or equal to said NT* said alpha2;
computing an impact factor (IF) of a plurality of impact factors as CIDX/NT, wherein said IF is associated with said X;
computing a summed impact factor (SumIF) by summing said plurality of impact factors, wherein a second impact factor of said plurality of impact factors is associated with a student of said plurality of all set positively influenced students; and
computing said SQ as said SumIF/said Sn.

4. The method of claim 1, wherein said step for computing said mentee count further comprising the steps of:
determining a student (X) of said plurality of all set positively influenced students;
determining a plurality of positively influenced student X sets based on plurality of positively influenced student sets, wherein said X is a member of each of said plurality of positively influenced student X sets;
arranging said plurality of positively influenced student X sets in the chronological order resulting in a plurality of ordered positively influenced student X sets;
determining a first time stamp (TSX1) associated with an ordered positively influenced student X set of said plurality of ordered positively influenced student X sets, wherein said ordered positively influenced student X set is the first element of said plurality of ordered positively influenced student X sets;
determining a first performance measure (PM0) of said X based on said plurality of assessments and said UMG database, wherein said PM0 is before said TSX1;
computing a number of elements (NX) in said plurality of ordered positively influenced student X sets;
determining an ordered positively influenced student X set of said plurality of ordered positively influenced student X sets;
determining an analysis Y sub-period of said plurality of analysis sub-periods based on said ordered positively influenced student X set;
determining a second performance measure (PMy) based on said analysis Y sub-period, said plurality of assessments, and said UMG database;
incrementing a mentoring count by 1, wherein said PMy is better than said PM0; and
incrementing said mentee count by 1, wherein said mentoring count exceeds said NX * a fifth pre-defined threshold (beta2).

5. The method of claim 1, wherein said step for computing said dependability count further comprising the steps of:
determining a student (X) of said plurality of all set positively influenced students;
determining a plurality of positively influenced student X sets based on plurality of positively influenced student sets, wherein said X is a member of each of said plurality of positively influenced student X sets;
computing a number of elements (NX) in said plurality of positively influenced student X sets;
computing a plurality of typical Y time intervals of a plurality of typical X time intervals based on a Y positively influenced student X set of said plurality of positively influenced student X sets, wherein said NX exceeds said N* a sixth pre-defined threshold (gamma1);
clustering said plurality of typical X time intervals to result in a plurality of clusters;
determining a number of time intervals (NC) in said plurality of typical X time intervals;
determining a plurality of cluster sizes based on said plurality of clusters, wherein a cluster size of said plurality of cluster sizes is a size of a cluster of said plurality of clusters;
selecting a cluster (CX) of said plurality of clusters, wherein the size of said plurality of cluster sizes associated with said cluster exceeds said NC* a seventh pre-defined threshold (gamma2); and
incrementing said dependability count by 1, wherein said CX is not NULL.

6. The method of claim 5, wherein said step for computing said plurality of typical Y time intervals further comprising the steps of:
determining said Y positively influenced student X set;
determining an analysis Y sub-period (APy) of said plurality of analysis sub-periods based on said Y positively influenced student X set;
determining a plurality of Y time intervals based on said X, said S, said APy, and said UMG database, wherein the duration of a Y time interval of said plurality of Y time intervals is greater than or equal to an eighth pre-defined threshold (gamma4);
clustering said plurality of Y time intervals to result in a plurality of Y time interval clusters, wherein a first time interval (TI1) and a second time interval (TI2) are in a Y time interval cluster of said plurality of Y time interval clusters, an absolute value of a difference between a first start time of TI1 and a second start time of TI2 is less than a ninth pre-defined threshold (gamma5), and an absolute value of a difference between a first end time of TI1 and a second end time of TI2 is less than said gamma5;
computing a number of elements (NT) in said plurality of Y time intervals;
computing a plurality of sizes of said plurality of Y time interval clusters, wherein a size of said plurality of sizes is the size of a Y time interval cluster of said plurality of Y time interval clusters;
selecting a Y time interval cluster of said plurality of Y time interval clusters into a plurality of selected Y time interval clusters, wherein the size of said Y time interval cluster exceeds said NT * a tenth pre-defined threshold (gamma6);
determining a plurality of selected Y time intervals based on said Y time interval cluster, wherein a selected Y time interval of said plurality of selected Y time intervals is a part of said Y time interval cluster;
computing a centroid of said plurality of selected Y time intervals; and
making said centroid a part of said plurality of typical Y time intervals.

7. The method of claim 6, wherein said step for computing said centroid further comprising the steps of:
determining a plurality of durations based on said plurality of selected Y time intervals, wherein a duration of said plurality of durations is a length of a Y time interval of said plurality of selected Y time intervals;
computing a mean duration (MD) based on said plurality of durations;
determining a plurality of start times based on said plurality of selected Y time intervals, wherein a start time of said plurality of start times is associated with a time interval of said plurality of selected Y time intervals;
computing a mean start time (MST) based on said plurality of start times;
determining a plurality of end times based on said plurality of selected Y time intervals, wherein an end time of said plurality of end times is associated with a time interval of said plurality of selected Y time intervals;
computing a mean end time (MET) based on said plurality of end times;
clustering of said plurality of durations to result in a plurality of duration clusters;
selecting a maximally populated duration cluster of said plurality of duration clusters based on the size of each of said plurality of duration clusters;
computing a mean duration prime (MD′) based on said maximally populated duration cluster;
computing a delta as the absolute value of a difference between said MD and said MD′;
computing a centroid start time as said MST−(said delta/2), wherein said MD is less than or equal to said MD′;
computing said centroid start time as said MST+(said delta/2), wherein said MD is greater than said MD′;
computing a centroid end time as said MET+(said delta/2), wherein said MD is less than or equal to said MD′;
computing said centroid end time as said MET−(said delta/2), wherein said MD is greater than said MD′; and
making said centroid start time and said centroid end time a part of said centroid.
